(19) United States
(12) Patent Application Publication
(10) Pub. No.: US 2024/0174551 A1
(43) Pub. Date: May 30, 2024

(54) ION EXCHANGEABLE GLASS COMPOSITIONS HAVING IMPROVED MECHANICAL DURABILITY

(71) Applicant: CORNING INCORPORATED, CORNING, NY (US)

(72) Inventors: Xiaoju Guo, Pittsford, NY (US); Peter Joseph Lezzi, Corning, NY (US); Jian Luo, Cupertino, CA (US)

(21) Appl. No.: 18/517,504

(22) Filed: Nov. 22, 2023

Related U.S. Application Data
(60) Provisional application No. 63/428,181, filed on Nov. 28, 2022.

(51) Int. Cl. C03C 3/097

(52) U.S. Cl. CPC C03C 3/097; C03C 2203/10

(57) ABSTRACT

A glass composition includes: from 55 mol % to 70 mol % SiO₂; from 12.5 mol % to 17.25 mol % Al₂O₃; from 0.1 mol % to 3.5 mol % P₂O₅; from 0 mol % to 5.5 mol % B₂O₃; from 6 mol % to 10 mol % Li₂O; from 3 mol % to 10 mol % Na₂O; from 0 mol % to 3 mol % TiO₂; from 0 mol % to 3 mol % WO₃; and from 0 mol % to 3 mol % Y₂O₃. The sum of Al₂O₃ and B₂O₃ in the glass composition may be from 12.5 mol % to 22.5 mol %. The sum of TiO₂, WO₃, and Y₂O₃ in the glass composition may be from 0.2 mol % to 3 mol %.

This application claims the benefit of priority under 35 U.S.C. § 119 of U.S. Provisional Application Ser. No. 63/428,181 filed on Nov. 28, 2022, the content of which is relied upon and incorporated herein by reference in its entirety.

### FIELD

The present specification generally relates to glass compositions and, in particular, to ion exchangeable glass compositions having improved mechanical durability.

### TECHNICAL BACKGROUND

Glass articles, such as cover glasses, glass backplanes, housings, and the like, are employed in both consumer and commercial electronic devices, such as smart phones, tablets, portable media players, personal computers, and cameras. The mobile nature of these portable devices makes the devices and the glass articles included therein particularly vulnerable to accidental drops on hard surfaces, such as the ground. Moreover, glass articles, such as cover glasses, may include “touch” functionality which necessitates that the glass article be contacted by various objects including a user's fingers and/or stylus devices. Accordingly, the glass articles must be sufficiently robust to endure accidental dropping and regular contact without damage, such as scratching. Indeed, scratches introduced into the surface of the glass article may reduce the strength of the glass article as the scratches may serve as initiation points for cracks, leading to optical interference and catastrophic failure of the glass.

Accordingly, a need exists for alternative glasses which have improved mechanical properties.

### SUMMARY

According to a first aspect A1, a glass composition may comprise: greater than or equal to 55 mol % and less than or equal to 70 mol % SiO₂; greater than or equal to 12.5 mol % and less than or equal to 17.25 mol % Al₂O₃; greater than or equal to 0.1 mol % and less than or equal to 3.5 mol % P₂O₅; greater than or equal to 0 mol % and less than or equal to 5.5 mol % B₂O₃; greater than or equal to 6 mol % and less than or equal to 10 mol % Li₂O; greater than or equal to 3 mol % and less than or equal to 10 mol % Na₂O; greater than or equal to 0 mol % and less than or equal to 3 mol % TiO₂; greater than or equal to 0 mol % and less than or equal to 3 mol % WO₃; and greater than or equal to 0 mol % and less than or equal to 3 mol % Y₂O₃, wherein Al₂O₃+B₂O₃ is greater than or equal to 12.5 mol % and less than or equal to 22.5 mol %, and TiO₂+WO₃+Y₂O₃ is greater than or equal to 0.2 mol % and less than or equal to 3 mol %.

A second aspect A2 includes the glass composition according to the first aspect A1, wherein TiO₂+WO₃+Y₂O₃ is greater than or equal to 0.4 mol % and less than or equal to 3 mol %.

A third aspect A3 includes the glass composition according to the first aspect A1 or the second aspect A2, wherein Al₂O₃+B₂O₃ is greater than or equal to 13.5 mol % and less than or equal to 21.5 mol %.

A fourth aspect A4 includes the glass composition according to any one of the first through third aspects A1-A3, wherein the glass composition comprises greater than or equal to 0.1 mol % and less than or equal to 5.25 mol % B₂O₃.

A fifth aspect A5 includes the glass composition according to any one of the first through fourth aspects A1-A5, wherein the glass composition comprises greater than or equal to 13 mol % and less than or equal to 17 mol % Al₂O₃.

A sixth aspect A6 includes the glass composition according to any one of the first through fifth aspects A1-A5, wherein R₂O is greater than or equal to 9 mol % and less than or equal to 20 mol %, R₂O being the sum of Li₂O, Na₂O, and K₂O.

A seventh aspect A7 includes the glass composition according to any one of the first through sixth aspects A1-A6, wherein the glass composition comprises greater than 0 mol % and less than or equal to 1 mol % K₂O.

An eighth aspect A8 includes the glass composition according to any one of the first through seventh aspects A1-A7, wherein the glass composition comprises greater than 0 mol % and less than or equal to 6.5 mol % MgO.

A ninth aspect A9 includes the glass composition according to any one of the first through eighth aspects A1-A8, wherein the glass composition comprises greater than 0 mol % and less than or equal to 6.5 mol % CaO.

A tenth aspect A10 includes the glass composition according to any one of the first through ninth aspects A1-A9, wherein the glass composition comprises greater than 0 mol % and less than or equal to 1 mol % SnO₂.

An eleventh aspect A11 includes the glass composition according to any one of the first through tenth aspects A1-A10, wherein the glass composition comprises greater than or equal to 6.5 mol % and less than or equal to 9.5 mol % Li₂O.

A twelfth aspect A12 includes the glass composition according to any one of the first through eleventh aspects A1-A11, wherein the glass composition comprises greater than or equal to 4 mol % and less than or equal to 9.5 mol % Na₂O.

A thirteenth aspect A13 includes the glass composition according to any one of the first through twelfth aspects A1-A12, wherein the glass composition comprises greater than 0 mol % and less than or equal to 3 mol % TiO₂.

A fourteenth aspect A14 includes the glass composition according to any one of the first through thirteenth aspects A1-A13, wherein the glass composition comprises greater than 0 mol % and less than or equal to 3 mol % WO₃.

A fifteenth aspect A15 includes the glass composition according to any one of the first through fourteenth aspects A1-A14, wherein the glass composition comprises greater than 0 mol % and less than or equal to 3 mol % Y₂O₃.

A sixteenth aspect A16 includes the glass composition according to any one of the first through fifteenth aspects A1-A15, wherein the glass composition has a K_{Ic} fracture toughness as measured by a chevron notch short bar method greater than or equal to 0.7 MPa·m^{1/2}.

According to a seventeenth aspect A17, a glass article may comprise: greater than or equal to 55 mol % and less than or equal to 70 mol % SiO₂; greater than or equal to 12.5 mol % and less than or equal to 17.25 mol % Al₂O₃; greater than or equal to 0.1 mol % and less than or equal to 3.5 mol % P₂O₅; greater than or equal to 0 mol % and less than or equal to 5.5 mol % B₂O₃; greater than or equal to 6 mol % and less than or equal to 10 mol % Li₂O; greater than or equal to 3 mol % and less than or equal to 10 mol % Na₂O; greater than or equal to 0 mol % and less than or equal to 3 mol % TiO₂; greater than or equal to 0 mol % and less than or equal to 3 mol % WO₃; and greater than or equal to 0 mol % and less than or equal to 3 mol % Y₂O₃, wherein Al₂O₃+B₂O₃ is greater than or equal to 12.5 mol % and less than or equal to 22.5 mol %, and TiO₂+WO₃+Y₂O₃ is greater than or equal to 0.2 mol % and less than or equal to 3 mol %.

An eighteenth aspect A18 includes the glass article according to the seventeenth aspect A17, wherein TiO₂+WO₃+Y₂O₃ is greater than or equal to 0.4 mol % and less than or equal to 3 mol %.

A nineteenth aspect A19 includes the glass article according to the seventeenth aspect A17 or the eighteenth aspect A18, wherein Al₂O₃+B₂O₃ is greater than or equal to 13.5 mol % and less than or equal to 21.5 mol %.

A twentieth aspect A20 includes the glass article according to any one of the seventeenth through nineteenth aspects A17-A19, wherein the glass article comprises greater than or equal to 0.1 mol % and less than or equal to 5.25 mol % B₂O₃.

A twenty-first aspect A21 includes the glass article according to any one of the seventeenth through twentieth aspects A17-A20, wherein the glass article comprises greater than or equal to 13 mol % and less than or equal to 17 mol % Al₂O₃.

A twenty-second aspect A22 includes the glass article according to any one of the seventeenth through twenty-first aspects A17-A21, wherein R₂O is greater than or equal to 9 mol % and less than or equal to 20 mol %, R₂O being the sum of Li₂O, Na₂O, and K₂O.

A twenty-third aspect A23 includes the glass article according to any one of the seventeenth through twenty-second aspects A17-A22, wherein the glass article comprises greater than 0 mol % and less than or equal to 1 mol % K₂O

A twenty-fourth aspect A24 includes the glass article according to any one of the seventeenth through twenty-third aspects A17-A23, wherein the glass article comprises greater than 0 mol % and less than or equal to 6.5 mol % MgO.

A twenty-fifth aspect A25 includes the glass article according to any one of the seventeenth through twenty-fourth aspects A17-A24, wherein the glass article comprises greater than 0 mol % and less than or equal to 6.5 mol % CaO.

A twenty-sixth aspect A26 includes the glass article according to any one of the seventeenth through twenty-fifth aspects A17-A25, wherein the glass article comprises greater than 0 mol % and less than or equal to 1 mol % SnO₂.

A twenty-seventh aspect A27 includes the glass article according to any one of the seventeenth through twenty-sixth aspects A17-A26, wherein the glass article is an ion exchanged glass article.

A twenty-eighth aspect A28 includes the glass article according to the twenty-seventh aspect A27, wherein the ion exchanged glass article comprises a peak surface compressive stress greater than or equal to 450 MPa.

A twenty-ninth aspect A29 includes the glass article according to the twenty-seventh aspect A27 or the twenty-eighth aspect A28, wherein the ion exchanged glass article comprises a depth of layer greater than or equal to 5 μm.

A thirtieth aspect A30 includes the glass article according to any one of the twenty-seventh through twenty-ninth aspects A27-A29, wherein the ion exchanged glass article comprises a maximum central tension greater than or equal to 50 MPa, as measured at an article thickness of 0.8 mm.

According to a thirty-first aspect A31, a method of forming a glass article may comprise: heating a glass composition, the glass composition comprising: glass article may comprise: greater than or equal to 55 mol % and less than or equal to 70 mol % SiO₂; greater than or equal to 12.5 mol % and less than or equal to 17.25 mol % Al₂O₃; greater than or equal to 0.1 mol % and less than or equal to 3.5 mol % P₂O₅; greater than or equal to 0 mol % and less than or equal to 5.5 mol % B₂O₃; greater than or equal to 6 mol % and less than or equal to 10 mol % Li₂O; greater than or equal to 3 mol % and less than or equal to 10 mol % Na₂O; greater than or equal to 0 mol % and less than or equal to 3 mol % TiO₂; greater than or equal to 0 mol % and less than or equal to 3 mol % WO₃; and greater than or equal to 0 mol % and less than or equal to 3 mol % Y₂O₃, wherein Al₂O₃+B₂O₃ is greater than or equal to 12.5 mol % and less than or equal to 22.5 mol %, and TiO₂+WO₃+Y₂O₃ is greater than or equal to 0.2 mol % and less than or equal to 3 mol %; and cooling the glass composition to form the glass article.

A thirty-second aspect A32 includes the method according to the thirty-first aspect A31, further comprising strengthening the glass article in an ion exchange bath at a temperature greater than or equal to 350° C. to less than or equal to 500° C. for a time period greater than or equal to 1 hour to less than or equal to 24 hours to form an ion exchanged glass article.

A thirty-third aspect A33 includes the method according to the thirty-second aspect A32, wherein the ion exchanged glass article comprises a peak surface compressive stress greater than or equal to 450 MPa.

A thirty-fourth aspect A34 includes the method according to the thirty-second aspect A32 or the thirty-third aspect A33, wherein the ion exchanged glass article comprises a depth of layer greater than or equal to 5 μm.

A thirty-fifth aspect A34 includes the method according to any one of the thirty-second through thirty-fourth aspects A32-A34, wherein the ion exchanged glass article comprises a maximum central tension greater than or equal to 50 MPa, as measured at an article thickness of 0.8 mm.

A thirty-sixth aspect A36 includes the method according to any one of the thirty-second through thirty-fifth aspects A32-A35, wherein the ion exchange bath comprises NaNO₃.

A thirty-seventh aspect A37 includes the method according to any one of the thirty-second through thirty-sixth aspects A32-A36, wherein the ion exchange bath comprises KNO₃.

According to a thirty-eighth aspect 38, a consumer electronic device comprises a housing having a front surface, a back surface, and side surfaces; and electrical components provided at least partially within the housing, the electrical components including at least a controller, a memory, and a display, the display being provided at or adjacent the front surface of the housing; wherein the display includes the glass article of any one of the seventeenth through thirtieth aspects A17-A30.

Additional features and advantages of the glass compositions described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plan view of an electronic device incorporating any of the glass articles according to one or more embodiments described herein; and

FIG. 2 is a perspective view of the electronic device of FIG. 1.

### DETAILED DESCRIPTION

Reference will now be made in detail to various embodiments of ion exchangeable glass compositions having improved mechanical durability. According to embodiments, a glass composition may comprise greater than or equal to 55 mol % and less than or equal to 70 mol % SiO₂; greater than or equal to 12.5 mol % and less than or equal to 17.25 mol % Al₂O₃; greater than or equal to 0.1 mol % and less than or equal to 3.5 mol % P₂O₅; greater than or equal to 0 mol % and less than or equal to 5.5 mol % B₂O₃; greater than or equal to 6 mol % and less than or equal to 10 mol % Li₂O; greater than or equal to 3 mol % and less than or equal to 10 mol % Na₂O; greater than or equal to 0 mol % and less than or equal to 3 mol % TiO₂; greater than or equal to 0 mol % and less than or equal to 3 mol % WO₃; and greater than or equal to 0 mol % and less than or equal to 3 mol % Y₂O₃. The sum of Al₂O₃ and B₂O₃ (i.e., Al₂O₃+B₂O₃) in the glass composition and the resultant glass article may be from 12.5 mol % to 22.5 mol %. The sum of TiO₂, WO₃, and Y₂O₃ (i.e., TiO₂+WO₃+Y₂O₃) in the glass composition and the resultant glass article may be from 0.2 mol % to 3 mol %. Various embodiments of ion exchangeable glass compositions and glass articles formed therefrom will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and resultant glass articles described herein, the concentrations of constituent components (e.g., SiO₂, Al₂O₃, and the like) are specified in mole percent (mol %) on an oxide basis, unless otherwise specified.

The term “substantially free,” when used to describe the concentration and/or absence of a particular constituent component in a glass composition and the resultant glass article, means that the constituent component is not intentionally added to the glass composition and the resultant glass article. However, the glass composition and the resultant glass article may contain traces of the constituent component as a contaminant or tramp in amounts of less than 0.05 weight percent (wt %). As noted herein, the remainder of the application specifies the concentrations of constituent component in mol %. The contaminant or tramp amounts of the constituent components are listed in wt % for manufacturing purposes and one skilled in the art would understand the contaminant and tramp amounts being listed in wt %.

The terms “0 mol %” and “free,” when used to describe the concentration and/or absence of a particular constituent component in a glass composition and the resultant glass article, means that the constituent component is not present in glass composition and the resultant glass article.

Fracture toughness (K_{1C}) represents the ability of a glass composition to resist fracture. Fracture toughness is measured on a non-strengthened glass article, such as measuring the K_{1C} value prior to ion exchange treatment of the glass article, thereby representing a feature of a glass article prior to ion exchange. The fracture toughness test methods described herein are not suitable for glasses that have been exposed to ion exchange treatment. But, fracture toughness measurements performed as described herein on the same glass article prior to ion exchange treatment correlate to fracture toughness after ion exchange treatment, and are accordingly used as such. The chevron notched short bar (CNSB) method utilized to measure the K_{1C} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

Density, as described herein, is measured by the buoyancy method of ASTM C693-93.

The term “strain point,” as used herein, refers to the temperature at which the viscosity of the glass composition is 1×10^{14.68} poise as measured in accordance with ASTM C598.

The term “melting point,” as used herein, refers to the temperature at which the viscosity of the glass composition is 200 poise as measured in accordance with ASTM C338.

The term “softening point,” as used herein, refers to the temperature at which the viscosity of the glass composition is 1×10^{7.6} poise. The softening point is measured according to the parallel plate viscosity method which measures the viscosity of inorganic glass from 10⁷ to 10⁹ poise as a function of temperature, similar to ASTM C1351M.

The term “annealing point” or “effective annealing temperature” as used herein, refers to the temperature at which the viscosity of the glass composition is 1×10^{13.18} poise as measured in accordance with ASTM C598.

The elastic modulus (also referred to as Young's modulus) of the glass composition, as described herein, is provided in units of gigapascals (GPa) and is measured in accordance with ASTM C623.

The shear modulus of the glass composition, as described herein, is provided in units of gigapascals (GPa). The shear modulus of the glass composition is measured in accordance with ASTM C623.

Poisson's ratio, as described herein, is measured in accordance with ASTM C623.

Refractive index, as described herein, is measured in accordance with ASTM E1967.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The values reported for surface compressive stress (CS) herein refer to the peak surface compressive stress, unless otherwise indicated. The maximum central tension (CT) values are measured using a SCALP technique known in the art. The values reported for central tension (CT) herein refer to the maximum central tension, unless otherwise indicated.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

As used herein, “depth of layer” (DOL) refers to the depth within a glass article at which an ion of metal oxide diffuses into the glass article where the concentration of the ion reaches a minimum value. DOL may be measured using electron probe microanalysis (EPMA).

The term “Vogel-Fulcher-Tamman (‘VFT’) relation,” as used herein, describes the temperature dependence of the viscosity and is represented by the following equation:

$$log η = A + \frac{B}{T - {T}_{o}}$$

where ρ is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (e.g., 200 P Temperature, 35000 P Temperature, and 200000 P Temperature) at any temperature above softening point may be calculated.

The term “liquidus viscosity,” as used herein, refers to the viscosity of the glass composition at the onset of devitrification (i.e., at the liquidus temperature as determined with the gradient furnace method according to ASTM C829-81).

The term “liquidus temperature,” as used herein, refers to the temperature at which the glass composition begins to devitrify as determined with the gradient furnace method according to ASTM C829-81.

Chemical strengthening processes have been used to achieve high strength and high toughness in alkali silicate glasses. The frangibility limit of a chemically strengthened glass is generally controlled by the fracture toughness of the components of the glass. Silica has a relatively low K_{Ic} fracture toughness of approximately 0.7 MPa·m^{1/2}, which constrains the K_{Ic} fracture toughness of silicate glasses to be limited to values of about 0.7 MPa·m^{1/2}. Particular oxides may increase the fracture toughness (e.g., ZrO₂, Ta₂O₅, TiO₂, HfO₂, La₂O₃, Y₂O₃, and WO₃). However, such oxides may be expensive, thereby increasing the cost of glass articles formed from the glass composition.

The addition of Al₂O₃ may increase the fracture toughness of the glass composition, but may cause the liquidus viscosity to decrease, making the glass composition difficult to form. The addition of B₂O₃ may also improve fracture toughness of the glass composition. However, the presence B₂O₃ may reduce the achievable central tension of the glass composition following ion exchange strengthening of the glass composition and may lead to volatility issues during the melting and forming processes.

Disclosed herein are glass compositions and glass articles formed therefrom which mitigate the aforementioned problems. Specifically, the glass compositions and resultant glass articles disclosed herein comprise alkali oxides (i.e., Li₂O and Na₂O), a relatively high sum of Al₂O₃ and B₂O₃ (e.g., Al₂O₃+B₂O₃ is greater than or equal to 12.5 mol %), and a relatively high sum of TiO₂, WO₃, and Y₂O₃ (e.g., TiO₂+WO₃+Y₂O₃ is greater than or equal to 0.2 mol %), which results in ion exchangeable glass compositions having improved fracture toughness.

The glass compositions and resultant glass articles described herein may be described as aluminosilicate glass compositions and articles and comprise SiO₂ and Al₂O₃. The glass compositions and resultant glass articles described herein also include TiO₂, WO₃, and/or Y₂O₃ to increase fracture toughness. The glass compositions and resultant glass articles described herein also include alkali oxides, such as Li₂O and Na₂O, to enable the ion exchangeability of the glass compositions. The glass compositions and resultant glass articles described herein also include P₂O₅ to increase the efficiency of the ion exchange treatments.

SiO₂ is the primary glass former in the glass compositions described herein and may function to stabilize the network structure of the glass articles. The concentration of SiO₂ in the glass compositions and resultant glass articles should be sufficiently high (e.g., greater than or equal to 55 mol %) to provide basic glass forming capability. The amount of SiO₂ may be limited (e.g., to less than or equal to 70 mol %) to control the melting point of the glass composition, as the melting temperature of pure SiO₂ or high SiO₂ glasses is undesirably high. Thus, limiting the concentration of SiO₂ may aid in improving the meltability and the formability of the resulting glass article.

Accordingly, in embodiments, the glass composition and resultant glass article may comprise greater than or equal to 55 mol % and less than or equal to 70 mol % SiO₂. In embodiments, the concentration of SiO₂ in the glass composition and the resultant glass article may be greater than or equal to 55 mol %, greater than or equal to 57 mol %, or even greater than or equal to 59 mol %. In embodiments, the concentration of SiO₂ in the glass composition and the resultant glass article may be less than or equal to 70 mol %, less than or equal to 67 mol %, less than or equal to 65 mol %, or even less than or equal to 63 mol %. In embodiments, the concentration of SiO₂ in the glass composition and the resultant glass article may be greater than or equal to 55 mol % and less than or equal to 70 mol %, greater than or equal to 55 mol % and less than or equal to 67 mol %, greater than or equal to 55 mol % and less than or equal to 65 mol %, greater than or equal to 55 mol % and less than or equal to 63 mol %, greater than or equal to 57 mol % and less than or equal to 70 mol %, greater than or equal to 57 mol % and less than or equal to 67 mol %, greater than or equal to 57 mol % and less than or equal to 65 mol %, greater than or equal to 57 mol % and less than or equal to 63 mol %, greater than or equal to 59 mol % and less than or equal to 70 mol %, greater than or equal to 59 mol % and less than or equal to 67 mol %, greater than or equal to 59 mol % and less than or equal to 65 mol %, or even greater than or equal to 59 mol % and less than or equal to 63 mol %, or any and all sub-ranges formed from any of these endpoints.

Like SiO₂, Al₂O₃ may also stabilize the glass network and additionally provides improved mechanical properties and chemical durability to the resulting glass article. The amount of Al₂O₃ may also be tailored to the control the viscosity of the glass composition. The concentration of Al₂O₃ should be sufficiently high (e.g., greater than or equal to 12.5 mol %) such that the glass composition and the resultant glass article have the desired fracture toughness (e.g., greater than or equal to 0.7 MPa·m^{1/2}). However, if the amount of Al₂O₃ is too high (e.g., greater than 17.25 mol %), the viscosity of the melt may increase, thereby diminishing the formability of the glass composition. In embodiments, the glass composition and resultant glass article may comprise greater than or equal to 12.5 mol % and less than or equal to 17.25 mol % Al₂O₃. In embodiments, the glass composition and resultant glass article may comprise greater than or equal to 13 mol % and less than or equal to 17 mol % Al₂O₃. In embodiments, the concentration of Al₂O₃ in the glass composition and resultant glass article may be greater than or equal to 12.5 mol %, greater than or equal to 13 mol %, greater than or equal to 13.5 mol %, or even greater than or equal to 14 mol %. In embodiments, the concentration of Al₂O₃ in the glass composition and the resultant glass article may be less than or equal 17.25 mol %, less than or equal to 17 mol %, less than or equal to 16.5 mol %, or even less than or equal to 16 mol %. In embodiments, the concentration of Al₂O₃ in the glass composition and the resultant glass article may be greater than or equal 12.5 mol % and less than or equal to 17.25 mol %, greater than or equal 12.5 mol % and less than or equal to 17 mol %, greater than or equal 12.5 mol % and less than or equal to 16.5 mol %, greater than or equal 12.5 mol % and less than or equal to 16 mol %, greater than or equal 13 mol % and less than or equal to 17.25 mol %, greater than or equal 13 mol % and less than or equal to 17 mol %, greater than or equal 13 mol % and less than or equal to 16.5 mol %, greater than or equal 13 mol % and less than or equal to 16 mol %, greater than or equal 13.5 mol % and less than or equal to 17.25 mol %, greater than or equal 13.5 mol % and less than or equal to 17 mol %, greater than or equal 13.5 mol % and less than or equal to 16.5 mol %, greater than or equal 13.5 mol % and less than or equal to 16 mol %, greater than or equal 14 mol % and less than or equal to 17.25 mol %, greater than or equal 14 mol % and less than or equal to 17 mol %, greater than or equal 14 mol % and less than or equal to 16.5 mol %, or even greater than or equal 14 mol % and less than or equal to 16 mol %, or any and all sub-ranges formed from any of these endpoints.

Like SiO₂ and Al₂O₃, P₂O₅ may be added to the glass composition and the resultant glass article as a network former, thereby reducing the meltability and formability of the glass composition. Thus, P₂O₅ may be added in amounts that do not overly decrease these properties. The addition of P₂O₅ may also increase the diffusivity of ions in the glass article during ion exchange treatment, thereby increasing the efficiency of these treatments. In embodiments, the glass composition and resultant glass article may comprise greater than or equal to 0.1 mol % and less than or equal to 3.5 mol % P₂O₅. In embodiments, the concentration of P₂O₅ in the glass composition and resultant glass article may be greater than or equal to 0.1 mol %, greater than or equal to 0.25 mol %, greater than or equal to 0.5 mol %, or even greater than or equal to 1 mol %. In embodiments, the concentration of P₂O₅ in the glass composition and resultant glass article may be less than or equal to 3.5 mol %, less than or equal to 3 mol %, less than or equal to 2.5 mol %, or even less than or equal to 2 mol %. In embodiments, the concentration of P₂O₅ in the glass composition and resultant glass article may be greater than or equal to 0.1 mol % and less than or equal to 3.5 mol %, greater than or equal to 0.1 mol % and less than or equal to 3 mol %, greater than or equal to 0.1 mol % and less than or equal to 2.5 mol %, greater than or equal to 0.1 mol % and less than or equal to 2 mol %, greater than or equal to 0.25 mol % and less than or equal to 3.5 mol %, greater than or equal to 0.25 mol % and less than or equal to 3 mol %, greater than or equal to 0.25 mol % and less than or equal to 2.5 mol %, greater than or equal to 0.25 mol % and less than or equal to 2 mol %, greater than or equal to 0.5 mol % and less than or equal to 3.5 mol %, greater than or equal to 0.5 mol % and less than or equal to 3 mol %, greater than or equal to 0.5 mol % and less than or equal to 2.5 mol %, greater than or equal to 0.5 mol % and less than or equal to 2 mol %, greater than or equal to 1 mol % and less than or equal to 3.5 mol %, greater than or equal to 1 mol % and less than or equal to 3 mol %, greater than or equal to 1 mol % and less than or equal to 2.5 mol %, or even greater than or equal to 1 mol % and less than or equal to 2 mol %, or any and all sub-ranges formed from any of these endpoints.

The glass compositions and resultant glass articles described herein may further comprise B₂O₃. B₂O₃ decreases the melting temperature of the glass composition. In addition, B₂O₃ may also improve the damage resistance of the resulting glass article. When boron in the glass article is not charge balanced by alkali oxides or divalent cation oxides (such as MgO, and CaO), the boron will be in a trigonal-coordination state (or three-coordinated boron), which opens up the structure of the glass. The network around these three-coordinated boron atoms is not as rigid as tetrahedrally coordinated (or four-coordinated) boron. Without being bound by theory, it is believed that glass compositions that include three-coordinated boron can tolerate some degree of deformation before crack formation compared to four-coordinated boron. By tolerating some deformation, the Vickers indentation crack initiation threshold values increase. Fracture toughness of the glass compositions that include three-coordinated boron may also increase. B₂O₃ may be included in the glass composition and the resultant glass article to improve the formability and increase the fracture toughness of the glass composition and the resultant glass article. However, if the concentration of B₂O₃ is too high, the chemical durability and liquidus viscosity may diminish and volatilization and evaporation of B₂O₃ during melting becomes difficult to control. Moreover, it has been found that additions of boron significantly reduce diffusivity of alkali ions in the glass article, which, in turn, adversely impacts the ion exchange performance of the resultant glass. In particular, it has been found that additions of boron significantly increase the time required to achieve a given CT relative to glass compositions which are boron free. Therefore, the amount of B₂O₃ may be limited (e.g., less than or equal to 5.5 mol %) to maintain chemical durability, manufacturability of the glass composition, and desired ion exchangeability of the glass article.

In embodiments, the glass composition and resultant glass article may comprise greater than or equal to 0 mol % and less than or equal to 5.5 mol % B₂O₃. In embodiments, the glass composition and the resultant glass article may comprise greater than or equal to 0.1 mol % and less than or equal to 5.25 mol % B₂O₃. In embodiments, the concentration of B₂O₃ in the glass composition and the resultant glass article may be greater than or equal to 0 mol %, greater than or equal to 0.1 mol %, greater than or equal to 0.25 mol %, greater than or equal to 0.5 mol %, greater than or equal to 1 mol %, or even greater than or equal to 2 mol %. In embodiments, the concentration of B₂O₃ in the glass composition and the resultant glass article may be less than or equal to 5.5 mol %, less than or equal to 5.25 mol %, less than or equal to 5 mol %, less than or equal to 4.5 mol %, less than or equal to 4 mol %, less than or equal to 3.5 mol %, or even less than or equal to 3 mol %. In embodiments, the concentration of B₂O₃ in the glass composition and the resultant glass article may be greater than or equal to 0 mol % and less than or equal to 5.5 mol %, greater than or equal to 0 mol % and less than or equal to 5.25 mol %, greater than or equal to 0 mol % and less than or equal to 5 mol %, greater than or equal to 0 mol % and less than or equal to 4.5 mol %, greater than or equal to 0 mol % and less than or equal to 4 mol %, greater than or equal to 0 mol % and less than or equal to 3.5 mol %, greater than or equal to 0 mol % and less than or equal to 3 mol %, greater than or equal to 0.25 mol % and less than or equal to 5.5 mol %, greater than or equal to 0.25 mol % and less than or equal to 5.25 mol %, greater than or equal to 0.25 mol % and less than or equal to 5 mol %, greater than or equal to 0.25 mol % and less than or equal to 4.5 mol %, greater than or equal to 0.25 mol % and less than or equal to 4 mol %, greater than or equal to 0.25 mol % and less than or equal to 3.5 mol %, greater than or equal to 0.25 mol % and less than or equal to 3 mol %, greater than or equal to 0.5 mol % and less than or equal to 5.5 mol %, greater than or equal to 0.5 mol % and less than or equal to 5.25 mol %, greater than or equal to 0.5 mol % and less than or equal to 5 mol %, greater than or equal to 0.5 mol % and less than or equal to 4.5 mol %, greater than or equal to 0.5 mol % and less than or equal to 4 mol %, greater than or equal to 0.5 mol % and less than or equal to 3.5 mol %, greater than or equal to 0.5 mol % and less than or equal to 3 mol %, greater than or equal to 1 mol % and less than or equal to 5.25 mol %, greater than or equal to 1 mol % and less than or equal to 5 mol %, greater than or equal to 1 mol % and less than or equal to 4.5 mol %, greater than or equal to 1 mol % and less than or equal to 4 mol %, greater than or equal to 1 mol % and less than or equal to 3.5 mol %, greater than or equal to 1 mol % and less than or equal to 3 mol %, greater than or equal to 2 mol % and less than or equal to 5.5 mol %, greater than or equal to 2 mol % and less than or equal to 5.25 mol %, greater than or equal to 2 mol % and less than or equal to 5 mol %, greater than or equal to 2 mol % and less than or equal to 4.5 mol %, greater than or equal to 2 mol % and less than or equal to 4 mol %, greater than or equal to 2 mol % and less than or equal to 3.5 mol %, or even greater than or equal to 2 mol % and less than or equal to 3 mol %, or any and all sub-ranges formed from any of these endpoints. In embodiments, the glass composition and the resultant glass article may be free or substantially free of B₂O₃.

The glass compositions and resultant glass articles described herein include a relatively high concentration of Al₂O₃ and B₂O₃, which may increase the fracture toughness of the glass compositions and the resultant glass articles. In embodiments, the total concentration or sum of Al₂O₃ and B₂O₃ (i.e., Al₂O₃ (mol %) +B₂O₃ (mol %)) in the glass composition and the resultant glass article may be greater than or equal to 12.5 mol % to provide enhanced fracture toughness. The total concentration of Al₂O₃ and B₂O₃ in the glass composition and the resultant glass article may be limited (e.g., less than or equal to 22.5 mol %) to control the liquidus temperature of the glass composition, as an increased total concentration of Al₂O₃ and B₂O₃ may increase the liquidus temperature. An increased liquidus temperature decreases the liquidus viscosity and stability of the glass composition so that the glass composition may no longer be suitable for downdrawing or fusion forming processes.

In embodiments, the total concentration of Al₂O₃ and B₂O₃ in the glass composition and the resultant glass article may be greater than or equal to 12.5 mol % and less than or equal to 22.5 mol %. In embodiments, the total concentration of Al₂O₃ and B₂O₃ in the glass composition and the resultant glass article may be greater than or equal to 13 mol % and less than or equal to 22 mol %. In embodiments, the total concentration of Al₂O₃ and B₂O₃ in the glass composition and the resultant glass article may be greater than or equal to 12.5 mol %, greater than or equal to 13.5 mol %, greater than or equal to 14.5 mol %, or even greater than or equal to 15.5 mol %. In embodiments, the total concentration of Al₂O₃ and B₂O₃ in the glass composition and the resultant glass article may be less than or equal to 22.5 mol %, less than or equal to 21.5 mol %, less than or equal to 20.5 mol %, less than or equal to 19.5 mol %, or even less than or equal to 18.5 mol %. In embodiments, the concentration amount of Al₂O₃ and B₂O₃ in the glass composition and the resultant glass article may be greater than or equal to 12.5 mol % and less than or equal to 22.5 mol %, greater than or equal to 12.5 mol % and less than or equal to 21.5 mol %, greater than or equal to 12.5 mol % and less than or equal to 20.5 mol %, greater than or equal to 12.5 mol % and less than or equal to 19.5 mol %, greater than or equal to 12.5 mol % and less than or equal to 18.5 mol %, greater than or equal to 13.5 mol % and less than or equal to 22.5 mol %, greater than or equal to 13.5 mol % and less than or equal to 21.5 mol %, greater than or equal to 13.5 mol % and less than or equal to 20.5 mol %, greater than or equal to 13.5 mol % and less than or equal to 19.5 mol %, greater than or equal to 13.5 mol % and less than or equal to 18.5 mol %, greater than or equal to 14.5 mol % and less than or equal to 22.5 mol %, greater than or equal to 14.5 mol % and less than or equal to 21.5 mol %, greater than or equal to 14.5 mol % and less than or equal to 20.5 mol %, greater than or equal to 14.5 mol % and less than or equal to 19.5 mol %, greater than or equal to 14.5 mol % and less than or equal to 18.5 mol %, greater than or equal to 15.5 mol % and less than or equal to 22.5 mol %, greater than or equal to 15.5 mol % and less than or equal to 21.5 mol %, greater than or equal to 15.5 mol % and less than or equal to 20.5 mol %, greater than or equal to 15.5 mol % and less than or equal to 19.5 mol %, or even greater than or equal to 15.5 mol % and less than or equal to 18.5 mol %, or any and all sub-ranges formed from any of these endpoints.

As described hereinabove, the glass compositions may contain alkali oxides, such as Li₂O and Na₂O, to enable the ion exchangeability of the glass compositions. Li₂O aids in the ion exchangeability of the glass composition and also reduces the softening point of the glass composition thereby increasing the formability of the glass. In embodiments, the glass composition and the resultant glass article may comprise greater than or equal to 6 mol % and less than or equal to 10 mol % Li₂O. In embodiments, the glass composition and the resultant glass article may comprise greater than or equal to 6.5 mol % and less than or equal to 9.5 mol % Li₂O. In embodiments, the concentration of Li₂O in the glass composition and the resultant glass article may be greater than or equal to 6 mol %, greater than or equal to 6.5 mol %, greater than or equal to 7 mol %, greater than or equal to 7.5 mol %, or even greater than or equal to 8 mol %. In embodiments, the concentration of Li₂O in the glass composition and the resultant glass article may be less than or equal to 10 mol %, less than or equal to 9.5 mol % or even less than or equal to 9 mol %. In embodiments, the concentration of Li₂O in the glass composition and the resultant glass article may be greater than or equal to 6 mol % and less than or equal to 10 mol %, greater than or equal to 6 mol % and less than or equal to 9.5 mol %, greater than or equal to 6 mol % and less than or equal to 9 mol %, greater than or equal to 6.5 mol % and less than or equal to 10 mol %, greater than or equal to 6.5 mol % and less than or equal to 9.5 mol %, greater than or equal to 6.5 mol % and less than or equal to 9 mol %, greater than or equal to 7 mol % and less than or equal to 10 mol %, greater than or equal to 7 mol % and less than or equal to 9.5 mol %, greater than or equal to 7 mol % and less than or equal to 9 mol %, greater than or equal to 7.5 mol % and less than or equal to 10 mol %, greater than or equal to 7.5 mol % and less than or equal to 9.5 mol %, greater than or equal to 7.5 mol % and less than or equal to 9 mol %, greater than or equal to 8 mol % and less than or equal to 10 mol %, greater than or equal to 8 mol % and less than or equal to 9.5 mol %, or even greater than or equal to 8 mol % and less than or equal to 9 mol %, or any and all sub-ranges formed from any of these endpoints.

In addition to aiding in ion exchangeability of the glass composition, Na₂O decreases the melting point and improves formability of the glass composition. However, if too much Na₂O is added to the glass composition, the melting point may be too low. As such, in embodiments, the concentration of Li₂O present in the glass composition and the resultant glass article may be greater than the concentration of Na₂O present in the glass composition and the resultant glass article. In embodiments, the glass composition and the resultant glass article may comprise greater than or equal to 3 mol % and less than or equal to 10 mol % Na₂O. In embodiments, the glass composition and the resultant glass article may comprise greater than or equal to 3.5 mol % and less than or equal to 9.5 mol % Na₂O. In embodiments, the concentration of Na2O in the glass composition and the resultant glass article may be greater than or equal to 3 mol %, greater than or equal to 4 mol %, greater than or equal to 5 mol %, greater than or equal to 6 mol %, or even greater than or equal to 7 mol %. In embodiments, the concentration of Na₂O in the glass composition and the resultant glass article may be less than or equal to 10 mol %, less than or equal to 9.5 mol %, or even less than or equal to 9 mol %. In embodiments, the concentration of Na₂O in the glass composition and the resultant glass article may be greater than or equal to 3 mol % and less than or equal to 10 mol %, greater than or equal to 3 mol % and less than or equal to 9.5 mol %, greater than or equal to 3 mol % and less than or equal to 9 mol %, greater than or equal to 4 mol % and less than or equal to 10 mol %, greater than or equal to 4 mol % and less than or equal to 9.5 mol %, greater than or equal to 4 mol % and less than or equal to 9 mol %, greater than or equal to 5 mol % and less than or equal to 10 mol %, greater than or equal to 5 mol % and less than or equal to 9.5 mol %, greater than or equal to 5 mol % and less than or equal to 9 mol %, greater than or equal to 6 mol % and less than or equal to 10 mol %, greater than or equal to 6 mol % and less than or equal to 9.5 mol %, greater than or equal to 6 mol % and less than or equal to 9 mol %, greater than or equal to 7 mol % and less than or equal to 10 mol %, greater than or equal to 7 mol % and less than or equal to 9.5 mol %, or even greater than or equal to 7 mol % and less than or equal to 9 mol %, or any and all sub-ranges formed from any of these endpoints.

The glass compositions and the resultant glass articles described herein may further comprise alkali metal oxides other than Li₂O and Na₂O, such as K₂O. K₂O, when included, promotes ion exchange and may increase the depth of layer and decrease the melting point to improve the formability of the glass composition. However, adding too much K₂O may cause the surface compressive stress and melting point to be too low. Accordingly, in embodiments, the amount of K₂O added to the glass composition and the resultant glass article may be limited. In embodiments, the glass composition and the resultant glass article may comprise greater than 0 mol % and less than or equal to 1 mol % K₂O. In embodiments, the concentration of K₂O in the glass composition and the resultant glass article may be greater than or equal to 0 mol % or even greater than or equal to 0.1 mol %. In embodiments, the concentration of K₂O in the glass composition and the resultant glass article may be less than or equal less than or equal to 1 mol % or even less than or equal to 0.5 mol %. In embodiments, the concentration of K₂O in the glass composition and the resultant glass article may be greater than or equal to 0 mol % and less than or equal to 1 mol %, greater than or equal to 0 mol % and less than or equal to 0.5 mol %, greater than or equal to 0.1 mol % and less than or equal to 1 mol %, or even greater than or equal to 0.1 mol % and less than or equal to 0.5 mol %, or any and all sub-ranges formed from any of these endpoints. In embodiments, the glass composition and the resultant glass article may be free or substantially free of K₂O.

R₂O is the sum (in mol %) of Li₂O, Na₂O, and K₂O present in the glass composition and the resultant glass article (i.e., R₂O=Li₂O (mol %)+Na₂O (mol %)+K₂O (mol %). Like B₂O₃, these alkali oxides aid in decreasing the softening point and molding temperature of the glass composition, thereby offsetting the increase in the softening point and molding temperature of the glass composition due to higher amounts of SiO₂ in the glass composition, for example. The softening point and molding temperature may be further reduced by including combinations of alkali oxides (e.g., two or more alkali oxides) in the glass composition, a phenomenon referred to as the “mixed alkali effect.” However, it has been found that if the amount of alkali oxide is too high, the average coefficient of thermal expansion of the glass composition increases to greater than 100×10⁻⁷/° C., which may be undesirable.

In embodiments, the concentration of R₂O in the glass composition and the resultant glass article may be greater than or equal to 9 mol % and less than or equal to 20 mol %. In embodiments, the concentration of R₂O in the glass composition and the resultant glass article may be greater than or equal to 9 mol %, greater than or equal to 11 mol %, greater than or equal to 13 mol %, or even greater than or equal to 15 mol %. In embodiments, the concentration of R₂O in the glass composition and the resultant glass article may be less than or equal to 20 mol %, less than or equal to 19 mol %, or even less than or equal to 18 mol %. In embodiments, the concentration of R₂O in the glass composition and the resultant glass article may be greater than or equal to 9 mol % and less than or equal to 20 mol %, greater than or equal to 9 mol % and less than or equal to 19 mol %, greater than or equal to 9 mol % and less than or equal to 18 mol %, greater than or equal to 11 mol % and less than or equal to 20 mol %, greater than or equal to 11 mol % and less than or equal to 19 mol %, greater than or equal to 11 mol % and less than or equal to 18 mol %, greater than or equal to 13 mol % and less than or equal to 20 mol %, greater than or equal to 13 mol % and less than or equal to 19 mol %, greater than or equal to 13 mol % and less than or equal to 18 mol %, greater than or equal to 15 mol % and less than or equal to 20 mol %, greater than or equal to 15 mol % and less than or equal to 19 mol %, or even greater than or equal to 15 mol % and less than or equal to 18 mol %, or any and all sub-ranges formed from any of these endpoints.

The glass compositions and resultant glass articles described herein include a relatively high concentration of TiO₂, WO₃, and Y₂O₃, which may increase the fracture toughness of the glass compositions and the resultant glass articles. In embodiments, the total concentration or sum of TiO₂, WO₃, and Y₂O₃ (i.e., TiO₂ (mol %)+WO₃ (mol %)+Y₂O₃ (mol %)) in the glass composition and the resultant glass article may be greater than or equal to 0.2 mol % to provide enhanced fracture toughness. The total concentration of TiO₂, WO₃, and Y₂O₃ in the glass composition and the resultant glass article may be limited (e.g., less than or equal to 3 mol %) to limit the cost thereof and to ensure a desirable liquidus viscosity is achieved.

In embodiments, the total concentration of TiO₂, WO₃, and Y₂O₃ in the glass composition and the resultant glass article may be greater than or equal to 0.2 mol % and less than or equal to 3 mol %. In embodiments, the total concentration of TiO₂, WO₃, and Y₂O₃ in the glass composition and the resultant glass article may be greater than or equal to 0.4 mol % and less than or equal to 3 mol %. In embodiments, the total concentration of TiO₂, WO₃, and Y₂O₃ in the glass composition and the resultant glass article may be greater than or equal to 0.2 mol %, greater than or equal to 0.4 mol %, greater than or equal to 0.6 mol %, or even greater than or equal to 0.8 mol %. In embodiments, the total concentration of TiO₂, WO₃, and Y₂O₃ in the glass composition and the resultant glass article may be less than or equal to 3 mol %, less than or equal to 2.5 mol %, less than or equal to 2 mol %, less than or equal to 1.5 mol %, or even less than or equal to 1 mol %. In embodiments, the total concentration of TiO₂, WO₃, and Y₂O₃ in the glass composition and the resultant glass article may be greater than or equal to 0.2 mol % and less than or equal to 3 mol %, greater than or equal to 0.2 mol % and less than or equal to 2.5 mol %, greater than or equal to 0.2 mol % and less than or equal to 2 mol %, greater than or equal to 0.2 mol % and less than or equal to 1.5 mol %, greater than or equal to 0.2 mol % and less than or equal to 1 mol %, greater than or equal to 0.4 mol % and less than or equal to 3 mol %, greater than or equal to 0.4 mol % and less than or equal to 2.5 mol %, greater than or equal to 0.4 mol % and less than or equal to 2 mol %, greater than or equal to 0.4 mol % and less than or equal to 1.4 mol %, greater than or equal to 0.4 mol % and less than or equal to 1 mol %, greater than or equal to 0.6 mol % and less than or equal to 3 mol %, greater than or equal to 0.6 mol % and less than or equal to 2.5 mol %, greater than or equal to 0.6 mol % and less than or equal to 2 mol %, greater than or equal to 0.6 mol % and less than or equal to 1.5 mol %, greater than or equal to 0.6 mol % and less than or equal to 1 mol %, greater than or equal to 0.8 mol % and less than or equal to 3 mol %, greater than or equal to 0.8 mol % and less than or equal to 2.5 mol %, greater than or equal to 0.8 mol % and less than or equal to 2 mol %, greater than or equal to 0.8 mol % and less than or equal to 1.5 mol %, or even greater than or equal to 0.8 mol % and less than or equal to 1 mol %, or any and all sub-ranges formed from any of these endpoints.

In addition to improving fracture toughness, TiO₂ may provide UV-exposure resistance to a color change. In embodiments, the glass composition and the resultant glass article may comprise greater than or equal to 0 mol % and less than or equal to 3 mol % TiO₂. In embodiments, the glass composition and the resultant glass article may comprise greater than 0 mol % and less than or equal to 3 mol % TiO₂. In embodiments, the concentration of TiO₂ in the glass composition and the resultant glass article may be greater than or equal to 0 mol %, greater than or equal to 0.2 mol %, greater than or equal to 0.4 mol %, greater than or equal to 0.6 mol %, or even greater than or equal to 0.8 mol %. In embodiments, the concentration of TiO₂ in the glass composition and the resultant glass article may be less than or equal to 3 mol %, less than or equal to 2.5 mol %, less than or equal to 2 mol %, less than or equal to 1.5 mol %, or even less than or equal to 1 mol %. In embodiments, the concentration of TiO₂ in the glass composition and the resultant glass article may be greater than or equal to 0 mol % and less than or equal to 3 mol %, greater than or equal to 0 mol % and less than or equal to 2.5 mol %, greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0.2 mol % and less than or equal to 3 mol %, greater than or equal to 0.2 mol % and less than or equal to 2.5 mol %, greater than or equal to 0.2 mol % and less than or equal to 2 mol %, greater than or equal to 0.2 mol % and less than or equal to 1.5 mol %, greater than or equal to 0.2 mol % and less than or equal to 1 mol %, greater than or equal to 0.4 mol % and less than or equal to 3 mol %, greater than or equal to 0.4 mol % and less than or equal to 2.5 mol %, greater than or equal to 0.4 mol % and less than or equal to 2 mol %, greater than or equal to 0.4 mol % and less than or equal to 1.5 mol %, greater than or equal to 0.4 mol % and less than or equal to 1 mol %, greater than or equal to 0.6 mol % and less than or equal to 3 mol %, greater than or equal to 0.6 mol % and less than or equal to 2.5 mol %, greater than or equal to 0.6 mol % and less than or equal to 2 mol %, greater than or equal to 0.6 mol % and less than or equal to 1.5 mol %, greater than or equal to 0.6 mol % and less than or equal to 1 mol %, greater than or equal to 0.8 mol % and less than or equal to 3 mol %, greater than or equal to 0.8 mol % and less than or equal to 2.5 mol %, greater than or equal to 0.8 mol % and less than or equal to 2 mol %, greater than or equal to 0.8 mol % and less than or equal to 1.5 mol %, or even greater than or equal to 0.8 mol % and less than or equal to 1 mol %, or any and all sub-ranges formed from any of these endpoints. In embodiments, the glass composition and the resultant glass article may be free or substantially free of TiO₂.

In addition to improving fracture toughness, WO₃ may provide UV-exposure resistance to a color change and may increase the diffusivity of ions in the glass article during ion exchange treatment, thereby increasing the efficiency of these treatments. For example, WO₃-containing glass articles may also exhibit relatively fast ion exchange in terms of DOL. In embodiments, the glass composition and the resultant glass article may comprise greater than or equal to 0 mol % and less than or equal to 3 mol % WO₃. In embodiments, the glass composition and the resultant glass article may comprise greater than 0 mol % and less than or equal to 3 mol % WO₃. In embodiments, the concentration of WO₃ in the glass composition and the resultant glass article may be greater than or equal to 0 mol %, greater than or equal to 0.2 mol %, greater than or equal to 0.4 mol %, greater than or equal to 0.6 mol %, or even greater than or equal to 0.8 mol %. In embodiments, the concentration of WO₃ in the glass composition and the resultant glass article may be less than or equal to 3 mol %, less than or equal to 2.5 mol %, less than or equal to 2 mol %, less than or equal to 1.5 mol %, or even less than or equal to 1 mol %. In embodiments, the concentration of WO₃ in the glass composition and the resultant glass article may be greater than or equal to 0 mol % and less than or equal to 3 mol %, greater than or equal to 0 mol % and less than or equal to 2.5 mol %, greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0.2 mol % and less than or equal to 3 mol %, greater than or equal to 0.2 mol % and less than or equal to 2.5 mol %, greater than or equal to 0.2 mol % and less than or equal to 2 mol %, greater than or equal to 0.2 mol % and less than or equal to 1.5 mol %, greater than or equal to 0.2 mol % and less than or equal to 1 mol %, greater than or equal to 0.4 mol % and less than or equal to 3 mol %, greater than or equal to 0.4 mol % and less than or equal to 2.5 mol %, greater than or equal to 0.4 mol % and less than or equal to 2 mol %, greater than or equal to 0.4 mol % and less than or equal to 1.5 mol %, greater than or equal to 0.4 mol % and less than or equal to 1 mol %, greater than or equal to 0.6 mol % and less than or equal to 3 mol %, greater than or equal to 0.6 mol % and less than or equal to 2.5 mol %, greater than or equal to 0.6 mol % and less than or equal to 2 mol %, greater than or equal to 0.6 mol % and less than or equal to 1.5 mol %, greater than or equal to 0.6 mol % and less than or equal to 1 mol %, greater than or equal to 0.8 mol % and less than or equal to 3 mol %, greater than or equal to 0.8 mol % and less than or equal to 2.5 mol %, greater than or equal to 0.8 mol % and less than or equal to 2 mol %, greater than or equal to 0.8 mol % and less than or equal to 1.5 mol %, or even greater than or equal to 0.8 mol % and less than or equal to 1 mol %, or any and all sub-ranges formed from any of these endpoints. In embodiments, the glass composition and the resultant glass article may be free or substantially free of WO₃.

As noted hereinabove, Y₂O₃ may increase the fracture toughness of the glass compositions and the resultant glass articles described herein. In embodiments, the glass composition and the resultant glass article may comprise greater than or equal to 0 mol % and less than or equal to 3 mol % Y₂O₃. In embodiments, the glass composition and the resultant glass article may comprise greater than 0 mol % and less than or equal to 3 mol % Y₂O₃. In embodiments, the concentration of Y₂O₃ in the glass composition and the resultant glass article may be greater than or equal to 0 mol %, greater than or equal to 0.2 mol %, greater than or equal to 0.4 mol %, greater than or equal to 0.6 mol %, or even greater than or equal to 0.8 mol %. In embodiments, the concentration of Y₂O₃ in the glass composition and the resultant glass article may be less than or equal to 3 mol %, less than or equal to 2.5 mol %, less than or equal to 2 mol %, less than or equal to 1.5 mol %, or even less than or equal to 1 mol %. In embodiments, the concentration of Y₂O₃ in the glass composition and the resultant glass article may be greater than or equal to 0 mol % and less than or equal to 3 mol %, greater than or equal to 0 mol % and less than or equal to 2.5 mol %, greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0.2 mol % and less than or equal to 3 mol %, greater than or equal to 0.2 mol % and less than or equal to 2.5 mol %, greater than or equal to 0.2 mol % and less than or equal to 2 mol %, greater than or equal to 0.2 mol % and less than or equal to 1.5 mol %, greater than or equal to 0.2 mol % and less than or equal to 1 mol %, greater than or equal to 0.4 mol % and less than or equal to 3 mol %, greater than or equal to 0.4 mol % and less than or equal to 2.5 mol %, greater than or equal to 0.4 mol % and less than or equal to 2 mol %, greater than or equal to 0.4 mol % and less than or equal to 1.5 mol %, greater than or equal to 0.4 mol % and less than or equal to 1 mol %, greater than or equal to 0.6 mol % and less than or equal to 3 mol %, greater than or equal to 0.6 mol % and less than or equal to 2.5 mol %, greater than or equal to 0.6 mol % and less than or equal to 2 mol %, greater than or equal to 0.6 mol % and less than or equal to 1.5 mol %, greater than or equal to 0.6 mol % and less than or equal to 1 mol %, greater than or equal to 0.8 mol % and less than or equal to 3 mol %, greater than or equal to 0.8 mol % and less than or equal to 2.5 mol %, greater than or equal to 0.8 mol % and less than or equal to 2 mol %, greater than or equal to 0.8 mol % and less than or equal to 1.5 mol %, or even greater than or equal to 0.8 mol % and less than or equal to 1 mol %, or any and all sub-ranges formed from any of these endpoints. In embodiments, the glass composition and the resultant glass article may be free or substantially free of Y₂O₃.

The glass compositions described herein may further comprise MgO. MgO lowers the viscosity of the glass compositions, which enhances the formability, the strain point, and the Young's modulus, and may improve the ion exchangeability. However, when too much MgO is added to the glass composition, the diffusivity of sodium and potassium ions in the glass article decreases which, in turn, adversely impacts the ion exchange performance (i.e., the ability to ion-exchange) of the resultant glass. In embodiments, the glass composition and the resultant glass article may comprise greater than 0 mol % and less than or equal to 6.5 mol % MgO. In embodiments, the concentration of MgO in the glass composition and the resultant glass article may be greater than or equal to 0 mol %, greater than or equal to 0.1 mol %, greater than or equal to 0.5 mol %, greater than or equal to 1 mol %, or even greater than or equal to 2 mol %. In embodiments, the concentration of MgO in the glass composition and the resultant glass article may be less than or equal to 6.5 mol %, less than or equal to 5.5 mol %, less than or equal to 4.5 mol %, less than or equal to 3.5 mol %, or even less than or equal to 2.5 mol %. In embodiments, the concentration of MgO in the glass composition and the resultant glass article may be greater than or equal to 0 mol % and less than or equal to 6.5 mol %, greater than or equal to 0 mol % and less than or equal to 5.5 mol %, greater than or equal to 0 mol % and less than or equal to 4.5 mol %, greater than or equal to 0 mol % and less than or equal to 3.5 mol %, greater than or equal to 0 mol % and less than or equal to 2.5 mol %, greater than or equal to 0.1 mol % and less than or equal to 6.5 mol %, greater than or equal to 0.1 mol % and less than or equal to 5.5 mol %, greater than or equal to 0.1 mol % and less than or equal to 4.5 mol %, greater than or equal to 0.1 mol % and less than or equal to 3.5 mol %, greater than or equal to 0.1 mol % and less than or equal to 2.5 mol %, greater than or equal to 0.5 mol % and less than or equal to 6.5 mol %, greater than or equal to 0.5 mol % and less than or equal to 5.5 mol %, greater than or equal to 0.5 mol % and less than or equal to 4.5 mol %, greater than or equal to 0.5 mol % and less than or equal to 3.5 mol %, greater than or equal to 0.5 mol % and less than or equal to 2.5 mol %, greater than or equal to 1 mol % and less than or equal to 6.5 mol %, greater than or equal to 1 mol % and less than or equal to 5.5 mol %, greater than or equal to 1 mol % and less than or equal to 4.5 mol %, greater than or equal to 1 mol % and less than or equal to 3.5 mol %, greater than or equal to 1 mol % and less than or equal to 2.5 mol %, greater than or equal to 2 mol % and less than or equal to 6.5 mol %, greater than or equal to 2 mol % and less than or equal to 5.5 mol %, greater than or equal to 2 mol % and less than or equal to 4.5 mol %, greater than or equal to 2 mol % and less than or equal to 3.5 mol %, or even greater than or equal to 2 mol % and less than or equal to 2.5 mol %, or any and all sub-ranges formed from any of these endpoints. In embodiments, the glass composition and the resultant glass article may be free or substantially free of MgO.

The glass compositions described herein may further comprise CaO. CaO lowers the viscosity of a glass composition, which enhances the formability, the strain point and the Young's modulus, and may improve the ion exchangeability. However, when too much CaO is added to the glass composition, the diffusivity of sodium and potassium ions in the resultant glass article decreases which, in turn, adversely impacts the ion exchange performance (i.e., the ability to ion-exchange) of the resultant glass. In embodiments, the glass composition and the resultant glass article may comprise greater than 0 mol % and less than or equal to 6.5 mol % CaO. In embodiments, the concentration of CaO in the glass composition and the resultant glass article may be greater than or equal to 0 mol %, greater than or equal to 0.1 mol %, greater than or equal to 0.5 mol %, greater than or equal to 1 mol %, greater than or equal to 2 mol %, or even greater than or equal to 3 mol %. In embodiments, the concentration of CaO in the glass composition and the resultant glass article may be less than or equal to 6.5 mol %, less than or equal to 5.5 mol %, less than or equal to 4.5 mol %, or even less than or equal to 3.5 mol %. In embodiments, the concentration of CaO in the glass composition and the resultant glass article may be greater than or equal to 0 mol % and less than or equal to 6.5 mol %, greater than or equal to 0 mol % and less than or equal to 5.5 mol %, greater than or equal to 0 mol % and less than or equal to 4.5 mol %, greater than or equal to 0 mol % and less than or equal to 3.5 mol %, greater than or equal to 0.1 mol % and less than or equal to 6.5 mol %, greater than or equal to 0.1 mol % and less than or equal to 5.5 mol %, greater than or equal to 0.1 mol % and less than or equal to 4.5 mol %, greater than or equal to 0.1 mol % and less than or equal to 3.5 mol %, greater than or equal to 0.5 mol % and less than or equal to 6.5 mol %, greater than or equal to 0.5 mol % and less than or equal to 5.5 mol %, greater than or equal to 0.5 mol % and less than or equal to 4.5 mol %, greater than or equal to 0.5 mol % and less than or equal to 3.5 mol %, greater than or equal to 1 mol % and less than or equal to 6.5 mol %, greater than or equal to 1 mol % and less than or equal to 5.5 mol %, greater than or equal to 1 mol % and less than or equal to 4.5 mol %, greater than or equal to 1 mol % and less than or equal to 3.5 mol %, greater than or equal to 2 mol % and less than or equal to 6.5 mol %, greater than or equal to 2 mol % and less than or equal to 5.5 mol %, greater than or equal to 2 mol % and less than or equal to 4.5 mol %, greater than or equal to 2 mol % and less than or equal to 3.5 mol %, greater than or equal to 3 mol % and less than or equal to 6.5 mol %, greater than or equal to 3 mol % and less than or equal to 5.5 mol %, greater than or equal to 3 mol % and less than or equal to 4.5 mol %, or even greater than or equal to 3 mol % and less than or equal to 3.5 mol %, or any and all sub-ranges formed from any of these endpoints. In embodiments, the glass composition and the resultant glass article may be free or substantially free of CaO.

In embodiments, the glass compositions and the resultant glass article described herein may further include one or more fining agents. In embodiments, the fining agents may include, for example, SnO₂. In embodiments, the glass composition and the resultant glass article may comprise greater than 0 mol % and less than or equal to 1 mol % SnO₂. In embodiments, the concentration of SnO₂ in the glass composition and the resultant glass article may be greater than or equal to 0 mol %. In embodiments, the concentration of SnO₂ in the glass composition and the resultant glass article may be less than or equal to 1 mol %, less than or equal to 0.5 mol %, less than or equal to 0.3 mol %, or even less than or equal to 0.1 mol %. In embodiments, the concentration of SnO₂ in the glass composition and the resultant glass article may be greater than or equal to 0 mol % and less than or equal to 1 mol %, greater than or equal to 0 mol % and less than or equal to 0.5 mol %, greater than or equal to 0 mol % and less than or equal to 0.3 mol %, or even greater than or equal to 0 mol % and less than or equal to 0.1 mol %, or any and all sub-ranges formed from any of these endpoints. In embodiments, the glass composition and the resultant glass article may be substantially free of SnO₂.

In embodiments, the glass compositions described herein may further include tramp materials such as FeO, Fe₂O₃, MnO, MoO₃, La₂O₃, CdO, As₂O₃, Sb₂O₃, sulfur-based compounds, such as sulfates, halogens, or combinations thereof.

In embodiments, the glass composition may comprise: greater than or equal to 55 mol % and less than or equal to 70 mol % SiO₂; greater than or equal to 12.5 mol % and less than or equal to 17.25 mol % Al₂O₃; greater than or equal to 0.1 mol % and less than or equal to 3.5 mol % P₂O₅; greater than or equal to 0 mol % and less than or equal to 5.5 mol % B₂O₃; greater than or equal to 6 mol % and less than or equal to 10 mol % Li₂O; greater than or equal to 3 mol % and less than or equal to 10 mol % Na₂O; greater than or equal to 0 mol % and less than or equal to 3 mol % TiO₂; greater than or equal to 0 mol % and less than or equal to 3 mol % WO₃; and greater than or equal to 0 mol % and less than or equal to 3 mol % Y₂O₃, wherein Al₂O₃+B₂O₃ is greater than or equal to 12.5 mol % and less than or equal to 22.5 mol %, and TiO₂+WO₃+Y₂O₃ is greater than or equal to 0.2 mol % and less than or equal to 3 mol %.

The articles formed from the glass compositions described herein may be any suitable shape or thickness, which may vary depending on the particular application for use of the glass composition. Glass sheet embodiments may have a thickness greater than or equal to 30 μm, greater than or equal to 50 μm, greater than or equal to 100 μm, greater than or equal to 250 μm, greater than or equal to 500 μm, greater than or equal to 750 μm, or even greater than or equal to 1 mm. In embodiments, the glass sheet embodiments may have a thickness less than or equal to 6 mm, less than or equal to 5 mm, less than or equal to 4 mm, less than or equal to 3 mm, or even less than or equal to 2 mm. In embodiments, the glass sheet embodiments may have a thickness greater than or equal to 30 μm and less than or equal to 6 mm, greater than or equal to 30 μm and less than or equal to 5 mm, greater than or equal to 30 μm and less than or equal to 4 mm, greater than or equal to 30 μm and less than or equal to 3 mm, greater than or equal to 30 μm and less than or equal to 2 mm, greater than or equal to 50 μm and less than or equal to 6 mm, greater than or equal to 50 μm and less than or equal to 5 mm, greater than or equal to 50 μm and less than or equal to 4 mm, greater than or equal to 50 μm and less than or equal to 3 mm, greater than or equal to 50 μm and less than or equal to 2 mm, greater than or equal to 100 μm and less than or equal to 6 mm, greater than or equal to 100 μm and less than or equal to 5 mm, greater than or equal to 100 μm and less than or equal to 4 mm, greater than or equal to 100 μm and less than or equal to 3 mm, greater than or equal to 100 μm and less than or equal to 2 mm, greater than or equal to 250 μm and less than or equal to 6 mm, greater than or equal to 250 μm and less than or equal to 5 mm, greater than or equal to 250 μm and less than or equal to 4 mm, greater than or equal to 250 μm and less than or equal to 3 mm, greater than or equal to 250 μm and less than or equal to 2 mm, greater than or equal to 500 μm and less than or equal to 6 mm, greater than or equal to 500 μm and less than or equal to 5 mm, greater than or equal to 500 μm and less than or equal to 4 mm, greater than or equal to 500 μm and less than or equal to 3 mm, greater than or equal to 500 μm and less than or equal to 2 mm, greater than or equal to 750 μm and less than or equal to 6 mm, greater than or equal to 750 μm and less than or equal to 5 mm, greater than or equal to 750 μm and less than or equal to 4 mm, greater than or equal to 750 μm and less than or equal to 3 mm, greater than or equal to 750 μm and less than or equal to 2 mm, greater than or equal to 1 mm and less than or equal to 6 mm, greater than or equal to 1 mm and less than or equal to 5 mm, greater than or equal to 1 mm and less than or equal to 4 mm, greater than or equal to 1 mm and less than or equal to 3 mm, or even greater than or equal to 1 mm and less than or equal to 2 mm, or any and all sub-ranges formed from any of these endpoints.

As discussed hereinabove, the glass compositions and the resultant glass articles described herein may have increased fracture toughness such that the glass compositions and the resultant glass articles are more resistant to damage. In embodiments, the glass composition and the resultant glass article may have a K_{Ic} fracture toughness greater than or equal to 0.7 MPa·m^{1/2}, greater than or equal to 0.8 MPa·m^{1/2}, greater than or equal to 0.9 MPa·m^{1/2}, greater than or equal to 1.0 MPa·m^{1/2}, or even greater than or equal to 1.1 MPa·m^{1/2}.

In embodiments, the glass composition and the resultant glass article may have a density greater than or equal to 2.3 g/cm³, greater than or equal to 2.35 g/cm³, or even greater than or equal to 2.4 g/cm³. In embodiments, the glass composition and the resultant glass article may have a density less than or equal to 2.6 g/cm³, less than or equal to 2.55 g/cm³, or even less than or equal to 2.5 g/cm³. In embodiments, the glass composition and the resultant glass article may have a density greater than or equal to 2.3 g/cm³ and less than or equal to 2.6 g/cm³, greater than or equal to 2.3 g/cm³ and less than or equal to 2.55 g/cm³, greater than or equal to 2.3 g/cm³ and less than or equal to 2.5 g/cm³, greater than or equal to 2.35 g/cm³ and less than or equal to 2.6 g/cm³, greater than or equal to 2.35 g/cm³ and less than or equal to 2.55 g/cm³, greater than or equal to 2.35 g/cm³ and less than or equal to 2.5 g/cm³, greater than or equal to 2.4 g/cm³ and less than or equal to 2.6 g/cm³, greater than or equal to 2.4 g/cm³ and less than or equal to 2.55 g/cm³, or even greater than or equal to 2.4 g/cm³ and less than or equal to 2.5 g/cm³, or any and all sub-ranges formed from any of these endpoints.

In embodiments, the glass composition and the resultant glass article may have a strain point greater than or equal to 400° C., greater than or equal to 450° C., or even greater than or equal to 500° C. In embodiments, the glass composition and the resultant glass article may have a strain point less than or equal to 700° C., less than or equal to 650° C., or even less than or equal to 600° C. In embodiments, the glass composition and the resultant glass article may have a strain point greater than or equal to 400° C. and less than or equal to 700° C., greater than or equal to 400° C. and less than or equal to 650° C., greater than or equal to 400° C. and less than or equal to 600° C., greater than or equal to 450° C. and less than or equal to 700° C., greater than or equal to 450° C. and less than or equal to 650° C., greater than or equal to 450° C. and less than or equal to 600° C., greater than or equal to 500° C. and less than or equal to 700° C., greater than or equal to 500° C. and less than or equal to 650° C., or even greater than or equal to 500° C. and less than or equal to 600° C., or any and all sub-ranges formed from any of these endpoints.

In embodiments, the glass composition and the resultant glass article may have an annealing point greater than or equal to 500° C. or even greater than or equal to 550° C. In embodiments, the glass composition and the resultant glass article may have an annealing point less than or equal to 800° C. or even less than or equal to 700° C. In embodiments, the glass composition and the resultant glass article may have an annealing point greater than or equal to 500° C. and less than or equal to 800° C., greater than or equal to 500° C. and less than or equal to 700° C., greater than or equal to 550° C. and less than or equal to 800° C., or even greater than or equal to 550° C. and less than or equal to 700° C., or any and all sub-ranges formed from any of these endpoints.

In embodiments, the glass composition and the resultant glass article may have a Young's modulus greater than or equal to 60 GPa, greater than or equal to 65 GPa, or even greater than or equal to 70 GPa. In embodiments, the glass composition and the resultant glass article may have a Young's modulus less than or equal to 110 GPa, less than or equal to 100 GPa, or even less than or equal to 90 GPa. In embodiments, the glass composition and the resultant glass article may have a Young's modulus greater than or equal to 60 GPa and less than or equal to 110 GPa, greater than or equal to 60 GPa and less than or equal to 100 GPa, greater than or equal to 60 GPa and less than or equal to 90 GPa, greater than or equal to 65 GPa and less than or equal to 110 GPa, greater than or equal to 65 GPa and less than or equal to 100 GPa, greater than or equal to 65 GPa and less than or equal to 90 GPa, greater than or equal to 70 GPa and less than or equal to 110 GPa, greater than or equal to 70 GPa and less than or equal to 100 GPa, or even greater than or equal to 70 GPa and less than or equal to 90 GPa, or any and all sub-ranges formed from any of these endpoints.

In embodiments, the glass composition and the resultant glass article may have a shear modulus greater than or equal to 20 GPa, greater than or equal to 25 GPa, or even greater than or equal to 30 GPa. In embodiments, the glass composition and the resultant glass article may have a shear modulus less than or equal to 50 GPa, less than or equal to 45 GPa, or even less than or equal to 40 GPa. In embodiments, the glass composition and the resultant glass article may have a shear modulus greater than or equal to 20 GPa and less than or equal to 50 GPa, greater than or equal to 20 GPa and less than or equal to 45 GPa, greater than or equal to 20 GPa and less than or equal to 40 GPa, greater than or equal to 25 GPa and less than or equal to 50 GPa, greater than or equal to 25 GPa and less than or equal to 45 GPa, greater than or equal to 25 GPa and less than or equal to 40 GPa, greater than or equal to 30 GPa and less than or equal to 50 GPa, greater than or equal to 30 GPa and less than or equal to 45 GPa, or even greater than or equal to 30 GPa and less than or equal to 40 GPa, or any and all sub-ranges formed from any of these endpoints.

In embodiments, the glass compositions and the resultant glass articles described herein may have a relatively high Poisson's ratio, which increases the fracture energy such that the glass compositions are more resistant to damage. In embodiments, the glass composition and the resultant glass article may have a Poisson's ratio greater than or equal to 0.19, greater than or equal to 0.20, or even greater than or equal to 0.21. In embodiments, the glass composition and the resultant glass article may have a Poisson's ratio less than or equal to 0.25, less than or equal to 0.24, or even less than or equal to 0.23. In embodiments, the glass composition and the resultant glass article may have a Poisson's ratio greater than or equal to 0.19 and less than or equal to 0.25, greater than or equal to 0.19 and less than or equal to 0.24, greater than or equal to 0.19 and less than or equal to 0.23, greater than or equal to 0.20 and less than or equal to 0.25, greater than or equal to 0.20 and less than or equal to 0.24, greater than or equal to 0.20 and less than or equal to 0.23, greater than or equal to 0.21 and less than or equal to 0.25, greater than or equal to 0.21 and less than or equal to 0.24, or even greater than or equal to 0.21 and less than or equal to 0.23, or any and all sub-ranges formed from any of these endpoints.

In embodiments, the glass composition and the resultant glass article may have a refractive index greater than or equal to 1.4, greater than or equal to 1.45, or even greater than or equal to 1.5. In embodiments, the glass composition and the resultant glass article may have a refractive index less than or equal to 1.6 or even less than or equal to 1.55. In embodiments, the glass composition and the resultant glass article may have a refractive index greater than or equal to 1.4 and less than or equal to 1.6, greater than or equal to 1.4 and less than or equal to 1.55, greater than or equal to 1.45 and less than or equal to 1.6, greater than or equal to 1.45 and less than or equal to 1.55, greater than or equal to 1.5 and less than or equal to 1.6, or even greater than or equal to 1.5 and less than or equal to 1.55, or any and all sub-ranges formed from any of these endpoints.

In embodiments, the glass composition and the resultant glass article may have a stress optical coefficient (SOC) greater than or equal to 2.5 nm/mm/MPa or even greater than or equal to 2.75 nm/mm/MPa. In embodiments, the glass composition and the resultant glass article may have a SOC less than or equal to 3.5 nm/mm/MPa or even less than or equal to 3.25 nm/mm/MPa. In embodiments, the glass composition and the resultant glass article may have a SOC greater than or equal to 2.5 nm/mm/MPa and less than or equal to 3.5 nm/mm/MPa, greater than or equal to 2.5 nm/mm/MPa and less than or equal to 3.25 nm/mm/MPa, greater than or equal to 2.75 nm/mm/MPa and less than or equal to 3.5 nm/mm/MPa, or even greater than or equal to 2.75 nm/mm/MPa and less than or equal to 3.25 nm/mm/MPa, or any and all sub-ranges formed from any of these endpoints.

In embodiments, the glass composition and the resultant glass article may have a liquidus viscosity greater than or equal to 0.5 kP, greater than or equal to 1 kP, greater than or equal to 5 kP, greater than or equal to 10 kP, greater than or equal to 25 kP, or even greater than or equal to 50 kP. In embodiments, the glass composition and the resultant glass article may have a liquidus viscosity less than or equal to 300 kP, less than or equal to 250 kP, less than or equal to 200 kP, less than or equal to 150 kP, or even less than or equal to 100 kP. In embodiments, the glass composition and the resultant glass article may have a liquidus viscosity greater than or equal to 0.5 kP and less than or equal to 300 kP, greater than or equal to 0.5 kP and less than or equal to 250 kP, greater than or equal to 0.5 kP and less than or equal to 200 kP, greater than or equal to 0.5 kP and less than or equal to 150 kP, greater than or equal to 0.5 kP and less than or equal to 100 kP, greater than or equal to 1 kP and less than or equal to 300 kP, greater than or equal to 1 kP and less than or equal to 250 kP, greater than or equal to 1 kP and less than or equal to 200 kP, greater than or equal to 1 kP and less than or equal to 150 kP, greater than or equal to 1 kP and less than or equal to 100 kP, greater than or equal to 5 kP and less than or equal to 300 kP, greater than or equal to 5 kP and less than or equal to 250 kP, greater than or equal to 5 kP and less than or equal to 200 kP, greater than or equal to 5 kP and less than or equal to 150 kP, greater than or equal to 5 kP and less than or equal to 100 kP, greater than or equal to 10 kP and less than or equal to 300 kP, greater than or equal to 10 kP and less than or equal to 250 kP, greater than or equal to 10 kP and less than or equal to 200 kP, greater than or equal to 10 kP and less than or equal to 150 kP, greater than or equal to 10 kP and less than or equal to 100 kP, greater than or equal to 25 kP and less than or equal to 300 kP, greater than or equal to 25 kP and less than or equal to 250 kP, greater than or equal to 25 kP and less than or equal to 200 kP, greater than or equal to 25 kP and less than or equal to 150 kP, greater than or equal to 25 kP and less than or equal to 100 kP, greater than or equal to 50 kP and less than or equal to 300 kP, greater than or equal to 50 kP and less than or equal to 250 kP, greater than or equal to 50 kP and less than or equal to 200 kP, greater than or equal to 50 kP and less than or equal to 150 kP, or even greater than or equal to 50 kP and less than or equal to 100 kP, or any and all sub-ranges formed from any of these endpoints. These ranges of viscosities allow the glass compositions to be formed into sheets by a variety of different techniques including, without limitation, fusion forming, slot draw, floating, rolling, and other sheet-forming processes known to those in the art. However, it should be understood that other processes may be used for forming other articles (i.e., other than sheets).

In embodiments, the process for making a glass article includes heat treating the glass composition as described herein at one or more preselected temperatures for one or more preselected times to melt the glass composition and cooling the glass composition. In embodiments, the heat treatment for making a glass article may include (i) heating a glass composition at a rate of 1-100° C./min to glass melting temperature; (ii) maintaining the glass composition at the glass melting temperature for a time greater than or equal to 4 hours and less than or equal to 100 hours to produce a glass article; and (iii) cooling the formed glass article to room temperature. In embodiments, the glass melting temperature may be greater than or equal to 1500° C. and less than or equal to 1700° C.

In embodiments, the glass compositions described herein are ion exchangeable to facilitate strengthening the glass article made from the glass compositions. In typical ion exchange processes, smaller metal ions in the glass article are replaced or “exchanged” with larger metal ions of the same valence within a layer that is close to the outer surface of the glass article. The replacement of smaller ions with larger ions creates a compressive stress within the layer of the glass article. In embodiments, the metal ions are monovalent metal ions (e.g., Li⁺, Na⁺, K⁺, and the like), and ion exchange is accomplished by immersing the glass article in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion exchange process or processes that are used to strengthen the glass article may include, but are not limited to, immersion in a single bath or multiple baths of like or different compositions with washing and/or annealing steps between immersions.

Upon exposure to the glass article, the ion exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 450° C., greater than or equal to 370° C. and less than or equal to 440° C., greater than or equal to 360° C. and less than or equal to 420° C., greater than or equal to 370° C. and less than or equal to 400° C., greater than or equal to 375° C. and less than or equal to 475° C., greater than or equal to 400° C. and less than or equal to 500° C., greater than or equal to 410° C. and less than or equal to 490° C., greater than or equal to 420° C. and less than or equal to 480° C., greater than or equal to 430° C. and less than or equal to 470° C., or even greater than or equal to 440° C. and less than or equal to 460° C., or any and all sub-ranges between the foregoing values. In embodiments, the glass article may be exposed to the ion exchange solution for a duration greater than or equal to 1 hour and less than or equal to 24 hours, greater than or equal to 1 hour and less than or equal to 18 hours, greater than or equal to 1 hour and less than or equal to 12 hours, greater than or equal to 1 hour and less than or equal to 6 hours, greater than or equal to 2 hours and less than or equal to 24 hours, greater than or equal to 2 hours and less than or equal to 18 hours, greater than or equal to 2 hours and less than or equal to 12 hours, greater than or equal to 2 hours and less than or equal to 6 hours, greater than or equal to 4 hours and less than or equal to 24 hours, greater than or equal to 4 hours and less than or equal to 18 hours, or even greater than or equal to 4 hours and less than or equal to 12 hours, greater than or equal to 4 hours and less than or equal to 6 hours, or any and all sub-ranges formed from any of these endpoints.

In embodiments, the relatively increased K_{Ic} fracture toughness of the glass compositions described herein enables improved stress profiles (e.g., surface compressive stress, depth of layer, and maximum central tension) for the resultant glass articles, leading to improved mechanical performance.

In embodiments, a glass article made from the glass composition may have a surface compressive stress, after ion exchange strengthening, greater than or equal to 450 MPa. In embodiments, a glass article made from the glass composition may have a surface compressive stress, after ion exchange strengthening, greater than or equal to 450 MPa, greater than or equal to 500 MPa, greater than or equal to 550 MPa, greater than or equal to 600 MPa, or even greater than or equal to 650 MPa. In embodiments, a glass article made from the glass composition may have a surface compressive stress, after ion exchange strengthening, less than or equal to 900 MPa, less than or equal to 800 MPa, or even less than or equal to 700 MPa. In embodiments, a glass article made from the glass composition may have a surface compressive stress, after ion exchange strengthening, greater than or equal to 450 MPa and less than or equal to 900 MPa, greater than or equal to 450 MPa and less than or equal to 800 MPa, greater than or equal to 450 MPa and less than or equal to 700 MPa, greater than or equal to 500 MPa and less than or equal to 900 MPa, greater than or equal to 500 MPa and less than or equal to 800 MPa, greater than or equal to 500 MPa and less than or equal to 700 MPa, greater than or equal to 550 MPa and less than or equal to 900 MPa, greater than or equal to 550 MPa and less than or equal to 800 MPa, greater than or equal to 550 MPa and less than or equal to 700 MPa, greater than or equal to 600 MPa and less than or equal to 900 MPa, greater than or equal to 600 MPa and less than or equal to 800 MPa, greater than or equal to 600 MPa and less than or equal to 700 MPa, greater than or equal to 650 MPa and less than or equal to 900 MPa, greater than or equal to 650 MPa and less than or equal to 800 MPa, or even greater than or equal to 650 MPa and less than or equal to 700 MPa, or any and all sub-ranges formed from any of these endpoints.

In embodiments, a glass article made from the glass composition may have a depth of layer, after ion exchange strengthening, greater than or equal to 5 μm. In embodiments, a glass article made from the glass composition may have a depth of layer, after ion exchange strengthening, greater than or equal to 5 μm, greater than or equal to 7 μm, or even greater than or equal to 9 μm. In embodiments, a glass article made from the glass composition may have a depth of layer, after ion exchange strengthening, less than or equal to 20 μm, less than or equal to 18 μm, less than or equal to 16 μm, or even less than or equal to 14 μm. In embodiments, a glass article made from the glass composition may have a depth of layer, after ion exchange strengthening, greater than or equal to 5 μm and less than or equal to 20 μm, greater than or equal to 5 μm and less than or equal to 18 μm, greater than or equal to 5 μm and less than or equal to 16 μm, greater than or equal to 5 μm and less than or equal to 14 μm, greater than or equal to 7 μm and less than or equal to 20 μm, greater than or equal to 7 μm and less than or equal to 18 μm, greater than or equal to 7 μm and less than or equal to 16 μm, greater than or equal to 7 μm and less than or equal to 14 μm, greater than or equal to 9 μm and less than or equal to 20 μm, greater than or equal to 9 μm and less than or equal to 18 μm, greater than or equal to 9 μm and less than or equal to 16 μm, or even greater than or equal to 9 μm and less than or equal to 14 μm, or any and all sub-ranges formed from any of these endpoints.

In embodiments, a glass article made from the glass composition may have a maximum central tension, after ion exchange strengthening greater than or equal to 50 MPa, as measured at an article thickness of 0.8 mm. In embodiments, a glass article made from the glass composition may have a maximum central tension, after ion exchange strengthening, greater than or equal to 50 MPa, greater than or equal to 55 MPa, greater than or equal to 60 MPa, greater than or equal to 65 MPa, or even greater than or equal to 70 MPa, as measured at an article thickness of 0.8 mm. In embodiments, a glass article made from the glass composition may have a maximum central tension, after ion exchange strengthening, less than or equal to 125 MPa or even less than or equal to 100 MPa, as measured at an article thickness of 0.8 mm. In embodiments, a glass article made from the glass composition may have a maximum central tension after ion exchange strengthening greater than or equal to 50 MPa and less than or equal to 125 MPa, greater than or equal to 50 MPa and less than or equal to 100 MPa, greater than or equal to 55 MPa and less than or equal to 125 MPa, greater than or equal to 55 MPa and less than or equal to 100 MPa, greater than or equal to 60 MPa and less than or equal to 125 MPa, greater than or equal to 60 MPa and less than or equal to 100 MPa, greater than or equal to 65 MPa and less than or equal to 125 MPa, greater than or equal to 65 MPa and less than or equal to 100 MPa, greater than or equal to 75 MPa and less than or equal to 125 MPa, or even greater than or equal to 75 MPa and less than or equal to 100 MPa, or any and all sub-ranges formed from any of these endpoints, as measured at an article thickness of 0.8 mm.

The glass compositions and resultant glass articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass article as described herein.

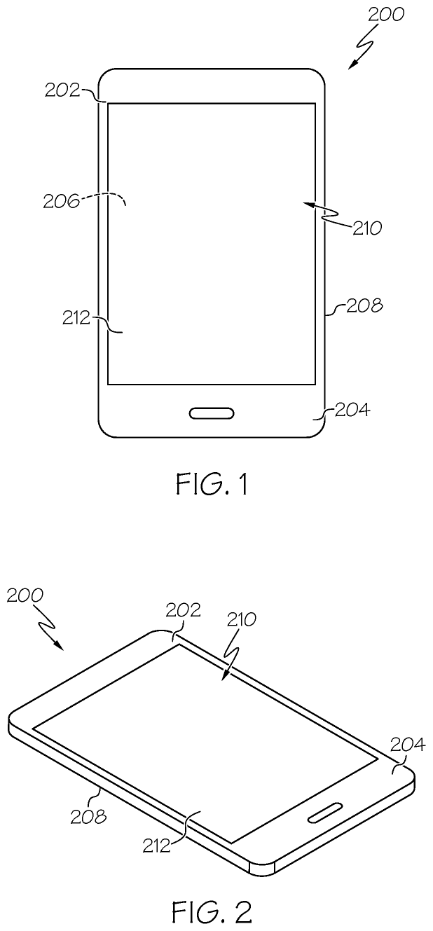

An exemplary electronic device incorporating any of the glass articles disclosed herein is shown in FIGS. 1 and 2. Specifically, FIGS. 1 and 2 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass articles disclosed herein.

### EXAMPLES

In order that various embodiments be more readily understood, reference is made to the following examples, which are intended to illustrate various embodiments of the glass compositions described herein.

Table 1 shows example glass compositions and a comparative glass composition (in terms of mol %) and the respective properties of the glass compositions. Glass articles are formed having the examples glass compositions E1-E30 and comparative glass composition C1.

TABLE 1

| Example | E1 | E2 | E3 | E4 | E5 |
|---|---|---|---|---|---|
| SiO₂ | 62.89 | 62.05 | 61.17 | 63.55 | 63.43 |
| Al₂O₃ | 16.06 | 15.96 | 15.86 | 15.20 | 14.28 |
| P₂O₅ | 2.62 | 2.60 | 2.64 | 2.61 | 2.68 |
| B₂O₃ | 0.49 | 0.54 | 0.59 | 0.49 | 0.54 |
| MgO | 0.33 | 0.33 | 0.33 | 0.33 | 0.32 |
| CaO | 0.02 | 0.02 | 0.03 | 0.02 | 0.02 |
| Li₂O | 8.16 | 8.15 | 8.05 | 8.29 | 8.22 |
| Na₂O | 7.92 | 7.86 | 7.85 | 7.98 | 8.00 |
| K₂O | 0.47 | 0.49 | 0.49 | 0.49 | 0.49 |
| TiO₂ | 0.01 | 0.01 | 0.01 | 0.01 | 0.01 |
| SnO₂ | 0.05 | 0.05 | 0.05 | 0.05 | 0.05 |
| Fe₂O₃ | 0.01 | 0.01 | 0.01 | 0.01 | 0.01 |
| WO₃ | 0.98 | 1.94 | 2.94 | 0.98 | 1.95 |
| Y₂O₃ | — | — | — | — | — |
| R₂O | 16.55 | 16.50 | 16.39 | 16.76 | 16.71 |
| Al₂O₃ + B₂O₃ | 16.55 | 16.50 | 16.45 | 15.69 | 14.82 |
| TiO₂ + WO₃ + Y₂O₃ | 0.99 | 1.95 | 2.95 | 0.99 | 1.96 |
| Density (g/cm³) | 2.447 | 2.494 | 2.529 | 2.447 | 2.485 |
| Strain Pt. (° C.) | 574.6 | 566.7 | 567.2 | 559.8 | 575 |
| Anneal Pt. (° C.) | 625.2 | 616.9 | 617.5 | 609.4 | 626.8 |
| Young's Modulus (GPa) | 76.3 | 75.8 | 75.0 | 76.2 | 75.0 |
| Shear modulus (GPa) | 31.6 | 31.2 | 31.0 | 31.5 | 31.1 |
| Poisson's ratio | 0.21. | 0.214 | 0.209 | 0.208 | 0.206 |
| K_{Ic} (CN) (MPa · m^{1/2}) | 0.695 | 0.734 | 0.721 | 0.699 | — |
| Refractive index | 1.5079 | 1.5116 | 1.5142 | 1.5075 | 1.5092 |
| SOC (nm/mm/MPa) | 2.961 | 2.941 | 2.965 | 2.939 | 2.982 |
| VFT A | −3.432 | −4.056 | −3.339 | −3.561 | −3.632 |
| VFT B | 8901.5 | 10467.5 | 8630.1 | 9521.8 | 9887.9 |
| VFT To | 58.9 | −51.8 | 55.8 | −4.7 | −66.1 |
| Liquidus (gradient boat) | 24 | 24 | 24 | 24 | 24 |
| duration (hours) | | | | | |
| Air interface liquidus | 1105 | 1095 | 1080 | 1075 | 1080 |
| temperature (° C.) | | | | | |
| Internal liquidus temperature | 1105 | 1095 | 1080 | 1070 | 1080 |
| (° C.) | | | | | |
| Platinum interface liquidus | 1100 | 1080 | 1075 | 1075 | 1055 |
| temperature (° C.) | | | | | |
| Liquidus Viscosity (kP) | 119 | 118 | 122 | 199 | 99 |

| Example | E6 | E7 | E8 | E9 | E10 |
|---|---|---|---|---|---|
| SiO₂ | 64.37 | 63.06 | 62.44 | 61.86 | 63.67 |
| Al₂O₃ | 13.47 | 15.94 | 15.78 | 15.59 | 15.09 |
| P₂O₅ | 2.42 | 2.60 | 2.55 | 2.53 | 2.63 |
| B₂O₃ | 0.62 | 0.43 | 0.42 | 0.42 | 0.43 |
| MgO | 0.31 | 0.32 | 0.32 | 0.31 | 0.32 |
| CaO | 0.02 | 0.02 | 0.02 | 0.02 | 0.02 |
| Li₂O | 8.09 | 8.31 | 8.35 | 8.34 | 8.39 |
| Na₂O | 7.85 | 7.89 | 7.80 | 7.74 | 8.00 |
| K₂O | 0.47 | 0.48 | 0.48 | 0.47 | 0.49 |
| TiO₂ | 0.01 | 0.01 | 0.01 | 0.00 | 0.01 |
| SnO₂ | 0.04 | 0.05 | 0.04 | 0.04 | 0.05 |
| Fe₂O₃ | 0.01 | 0.01 | 0.01 | 0.0 | 0.01 |
| WO₃ | 2.32 | — | — | — | — |
| Y₂O₃ | — | 0.96 | 1.94 | 2.89 | 0.97 |
| R₂O | 16.41 | 16.68 | 16.63 | 16.55 | 16.88 |
| Al₂O₃ + B₂O₃ | 14.09 | 16.37 | 16.20 | 16.01 | 15.52 |
| TiO₂ + WO₃ + Y₂O₃ | 2.33 | 0.97 | 1.95 | 2.89 | 0.98 |
| Density (g/cm³) | — | 2.458 | 2.510 | 2.563 | 2.457 |
| Strain Pt. (° C.) | — | 603.5 | 609.5 | 622.9 | 595.4 |
| Anneal Pt. (° C.) | — | 654 | 658.7 | 671.9 | 646.5 |
| Young's Modulus (GPa) | — | 79.4 | 81.7 | 82.5 | 79.2 |
| Shear modulus (GPa) | — | 32.8 | 33.6 | 33.9 | 32.7 |
| Poisson's ratio | — | 0.213 | 0.217 | 0.217 | 0.212 |
| K_{Ic} (CN) (MPa · m^{1/2}) | — | — | — | — | — |
| Refractive index | — | 1.513 | 1.5176 | 1.5284 | 1.5123 |
| SOC (nm/mm/MPa) | — | 2.917 | 2.841 | 2.797 | 2.928 |
| VFT A | — | −3.064 | −1.631 | 0.56 | −3.059 |
| VFT B | — | 7761.5 | 4276.2 | 1042 | 7658.1 |
| VFT To | — | 140.6 | 459.7 | 918.9 | 138.1 |
| Liquidus (gradient boat) | — | 24 | 24 | 24 | 24 |
| duration (hours) | | | | | |
| Air interface liquidus | — | >1310 | >1315 | >1375 | >1280 |
| temperature (° C.) | | | | | |
| Internal liquidus temperature | — | >1310 | >1315 | >1375 | >1280 |
| (° C.) | | | | | |
| Platinum interface liquidus | — | >1310 | >1315 | >1375 | >1280 |
| temperature (° C.) | | | | | |
| Liquidus Viscosity (kP) | — | <4 | <2 | <1 | <4 |

| Example | E11 | E12 | E13 | E14 | E15 |
|---|---|---|---|---|---|
| SiO₂ | 63.80 | 63.82 | 63.05 | 62.4 | 61.83 |
| Al₂O₃ | 14.09 | 13.08 | 15.96 | 15.79 | 15.64 |
| P₂O₅ | 2.58 | 2.61 | 2.58 | 2.57 | 2.56 |
| B₂O₃ | 0.43 | 0.42 | 0.43 | 0.43 | 0.43 |
| MgO | 0.32 | 0.33 | 0.32 | 0.31 | 0.31 |
| CaO | 0.02 | 0.02 | 0.02 | 0.02 | 0.02 |
| Li₂O | 8.46 | 8.51 | 8.24 | 8.20 | 8.1 |
| Na₂O | 7.96 | 7.96 | 7.91 | 7.84 | 7.77 |
| K₂O | 0.49 | 0.49 | 0.48 | 0.48 | 0.47 |
| TiO₂ | 0.01 | — | 0.95 | 1.91 | 2.82 |
| SnO₂ | 0.04 | 0.04 | 0.05 | 0.05 | 0.05 |
| Fe₂O₃ | 0.01 | 0.01 | 0.01 | 0.01 | 0.01 |
| WO₃ | — | — | — | — | — |
| Y₂O₃ | 1.97 | 2.96 | — | — | — |
| R₂O | 16.91 | 16.96 | 16.63 | 16.52 | 16.34 |
| Al₂O₃ + B₂O₃ | 14.52 | 13.50 | 16.39 | 16.22 | 16.07 |
| TiO₂ + WO₃ + Y₂O₃ | 1.98 | 2.96 | 0.95 | 1.91 | 2.82 |
| Density (g/cm³) | 2.509 | 2.561 | 2.408 | 2.416 | 2.427 |
| Strain Pt. (° C.) | 580.3 | 592 | 573.9 | 568.9 | 577.5 |
| Anneal Pt. (° C.) | 629.6 | 641.3 | 624.4 | 617.8 | 626.5 |
| Young's Modulus (GPa) | 81.3 | 81.7 | 76.9 | 77.2 | 77.7 |
| Shear modulus (GPa) | 33.5 | 33.6 | 31.9 | 31.9 | 32.1 |
| Poisson's ratio | 0.212 | 0.214 | 0.205 | 0.212 | 0.213 |
| K_{Ic} (CN) (MPa · m^{1/2}) | — | — | — | — | — |
| Refractive index | 1.5198 | 1.5269 | 1.5096 | 1.5148 | 1.5212 |
| SOC (nm/mm/MPa) | 2.825 | 2.802 | 3.016 | 3.073 | 3.086 |
| VFT A | −0.726 | −1.353 | −3.469 | −3.481 | −3.441 |
| VFT B | 2817.9 | 3673.2 | 9002.4 | 9035 | 8927.3 |
| VFT To | 621.2 | 504.0 | 54.6 | 38.1 | 28.3 |
| Liquidus (gradient boat) | 24 | 24 | 24 | 24 | 24 |
| duration (hours) | | | | | |
| Air interface liquidus | >1335 | >1320 | 1120 | 1105 | 1100 |
| temperature (° C.) | | | | | |
| Internal liquidus temperature | >1335 | >1320 | 1115 | 1100 | 1095 |
| (° C.) | | | | | |
| Platinum interface liquidus | >1335 | >1320 | 1105 | 1095 | 1090 |
| temperature (° C.) | | | | | |
| Liquidus Viscosity (kP) | <2 | <1 | 105 | 106 | 85 |

| Example | E16 | E17 | E18 | E19 | E20 |
|---|---|---|---|---|---|
| SiO₂ | 63.67 | 63.71 | 63.75 | 62.35 | 62.76 |
| Al₂O₃ | 15.1 | 14.12 | 13.11 | 14.22 | 13.99 |
| P₂O₅ | 2.63 | 2.63 | 2.62 | 0.50 | 0.50 |
| B₂O₃ | 0.43 | 0.42 | 0.43 | 5.21 | 5.03 |
| MgO | 0.32 | 0.33 | 0.32 | 0.09 | 0.08 |
| CaO | 0.02 | 0.02 | 0.02 | 3.31 | 3.27 |
| Li₂O | 8.35 | 8.34 | 8.33 | 7.54 | 7.71 |
| Na₂O | 7.97 | 7.95 | 7.97 | 4.58 | 4.54 |
| K₂O | 0.49 | 0.49 | 0.48 | 0.21 | 0.21 |
| TiO₂ | 0.97 | 1.93 | 2.90 | 0.01 | 0.01 |
| SnO₂ | 0.05 | 0.05 | 0.05 | 0.05 | 0.05 |
| Fe₂O₃ | 0.01 | 0.01 | 0.01 | 0.01 | 0.01 |
| WO₃ | — | — | — | 1.92 | — |
| Y₂O₃ | — | — | — | — | 2.00 |
| R₂O | 16.81 | 16.78 | 16.78 | 12.33 | 12.46 |
| Al₂O₃ + B₂O₃ | 15.53 | 14.54 | 13.54 | 19.43 | 19.02 |
| TiO₂ + WO₃ + Y₂O₃ | 0.97 | 1.93 | 2.90 | 1.93 | 2.01 |
| Density (g/cm³) | 2.408 | 2.416 | 2.423 | 2.488 | 2.51 |
| Strain Pt. (° C.) | 561.1 | 560.6 | 568.3 | 538.5 | 562.5 |
| Anneal Pt. (° C.) | 610.8 | 609.4 | 617.5 | 584.8 | 609.8 |
| Young's Modulus (GPa) | 76.9 | 77.0 | 77.3 | 75.8 | 81.4 |
| Shear modulus (GPa) | 31.8 | 31.9 | 31.9 | 31.0 | 33.2 |
| Poisson's ratio | 0.209 | 0.208 | 0.21 | 0.224 | 0.226 |
| K_{Ic} (CN) (MPa · m^{1/2}) | — | — | — | — | — |
| Refractive index | 1.5093 | 1.5145 | 1.5202 | 1.5184 | 1.5283 |
| SOC (nm/mm/MPa) | 3.016 | 3.031 | 3.065 | 3.079 | 2.935 |
| VFT A | −3.577 | −3.364 | −2.785 | −3.248 | −2.461 |
| VFT B | 9651.7 | 9195.6 | 7915.8 | 8165.5 | 5947.6 |
| VFT To | −25.7 | −29.4 | 22.7 | 39.8 | 214.2 |
| Liquidus (gradient boat) | 24 | 24 | 24 | 24 | 24 |
| duration (hours) | | | | | |
| Air interface liquidus | 1100 | 1060 | 1065 | 1175 | 1255 |
| temperature (° C.) | | | | | |
| Internal liquidus temperature | 1095 | 1055 | 1055 | 1175 | 1185 |
| (° C.) | | | | | |
| Platinum interface liquidus | 1095 | 1055 | 1050 | 1175 | 1195 |
| temperature (° C.) | | | | | |
| Liquidus Viscosity (kP) | 108 | 131 | 76 | 9 | 5 |

| Example | E21 | E22 | E23 | E24 | E25 |
|---|---|---|---|---|---|
| SiO₂ | 58.75 | 59.21 | 60.78 | 60.90 | 62.66 |
| Al₂O₃ | 16.27 | 16.04 | 14.53 | 14.28 | 15.06 |
| P₂O₅ | 1.99 | 1.96 | 0.48 | 0.49 | 0.50 |
| B₂O₃ | 3.55 | 3.36 | 3.0 | 2.72 | 5.03 |
| MgO | 0.03 | 0.03 | 2.45 | 2.45 | 0.08 |
| CaO | 0.01 | 0.01 | 0.02 | 0.02 | 3.27 |
| Li₂O | 8.90 | 9.05 | 7.89 | 8.10 | 7.59 |
| Na₂O | 8.23 | 8.16 | 8.67 | 8.66 | 4.58 |
| K₂O | 0.27 | 0.27 | 0.44 | 0.44 | 0.21 |
| TiO₂ | 0.01 | 0.01 | 0.01 | 0.01 | 0.01 |
| SnO₂ | 0.06 | 0.05 | 0.05 | 0.05 | 0.05 |
| Fe₂O₃ | 0.01 | 0.01 | 0.01 | 0.01 | 0.01 |
| WO₃ | 1.93 | — | 1.66 | — | 0.49 |
| Y₂O₃ | 0.00 | 2.02 | — | 2.02 | 0.49 |
| R₂O | 17.40 | 17.48 | 17.00 | 17.20 | 12.38 |
| Al₂O₃ + B₂O₃ | 19.82 | 19.40 | 17.54 | 17.00 | 20.09 |
| TiO₂ + WO₃ + Y₂O₃ | 1.94 | 2.03 | 1.67 | 2.03 | 0.99 |
| Density (g/cm³) | 2.485 | 2.505 | — | 2.532 | 2.451 |
| Strain Pt. (° C.) | 519 | 564.1 | — | 537.9 | 553.6 |
| Anneal Pt. (° C.) | 565.9 | 612.2 | — | 583.7 | 601.6 |
| Young's Modulus (GPa) | 74.0 | 79.2 | — | 82.1 | 78.3 |
| Shear modulus (GPa) | 30.3 | 32.3 | — | 33.6 | 32 |
| Poisson's ratio | 0.222 | 0.223 | — | 0.223 | 0.224 |
| K_{Ic} (CN) (MPa · m^{1/2}) | — | — | — | — | — |
| Refractive index | 1.5141 | 1.5232 | — | 1.5279 | 1.5186 |
| SOC (nm/mm/MPa) | 3.042 | 2.930 | — | 2.838 | 3.035 |
| VFT A | — | −1.928 | −3.255 | −2.367 | −3.106 |
| VFT B | — | 4814.2 | 8581.4 | 5805.2 | 7592.3 |
| VFT To | — | 327.3 | −44.8 | 203.3 | 107.3 |
| Liquidus (gradient boat) | 24 | 24 | 24 | 24 | 24 |
| duration (hours) | | | | | |
| Air interface liquidus | 1045 | >1350 | 1135 | 1215 | 1130 |
| temperature (° C.) | | | | | |
| Internal liquidus temperature | 1040 | >1350 | 1130 | 1180 | 1100 |
| (° C.) | | | | | |
| Platinum interface liquidus | 1035 | >1350 | 1115 | 1185 | 1090 |
| temperature (° C.) | | | | | |
| Liquidus Viscosity (kP) | — | — | 11 | 4 | 35 |

| Example | E26 | E27 | E28 | E29 | E30 |
|---|---|---|---|---|---|
| SiO₂ | 62.71 | 58.98 | 58.84 | 60.31 | 60.57 |
| Al₂O₃ | 14.10 | 17.07 | 16.12 | 15.24 | 14.37 |
| P₂O₅ | 0.49 | 1.97 | 1.97 | 0.49 | 0.49 |
| B₂O₃ | 4.95 | 3.52 | 3.58 | 3.33 | 2.94 |
| MgO | 0.08 | 0.03 | 0.03 | 2.46 | 2.46 |
| CaO | 3.24 | 0.01 | 0.01 | 0.02 | 0.02 |
| Li₂O | 7.66 | 8.93 | 8.96 | 8.04 | 8.06 |
| Na₂O | 4.58 | 8.20 | 8.25 | 8.66 | 8.69 |
| K₂O | 0.21 | 0.27 | 0.28 | 0.44 | 0.44 |
| TiO₂ | 0.01 | 0.01 | 0.01 | 0.01 | 0.01 |
| SnO₂ | 0.05 | 0.05 | 0.05 | 0.06 | 0.05 |
| Fe₂O₃ | 0.01 | 0.01 | 0.01 | 0.0 | 0.01 |
| WO₃ | 0.98 | 0.50 | 0.99 | 0.49 | 0.97 |
| Y₂O₃ | 0.99 | 0.50 | 1.00 | 0.50 | 1.00 |
| R₂O | 12.45 | 17.40 | 17.49 | 17.14 | 17.19 |
| Al₂O₃ + B₂O₃ | 19.05 | 20.59 | 19.70 | 18.57 | 17.31 |
| TiO₂ + WO₃ + Y₂O₃ | 1.98 | 1.0 | 2.00 | 1.00 | 1.98 |
| Density (g/cm³) | 2.503 | 2.448 | 2.500 | 2.475 | 2.529 |
| Strain Pt. (° C.) | 556.5 | 548.9 | 542.7 | 528.1 | 528.1 |
| Anneal Pt. (° C.) | 603.0 | 596.9 | 591.3 | 574 | 573 |
| Young's Modulus (GPa) | 78.7 | 76.4 | 71.1 | 79.4 | 79.8 |
| Shear modulus (GPa) | 32.1 | 31.2 | 29.2 | 32.5 | 32.7 |
| Poisson's ratio | 0.224 | 0.223 | 0.22 | 0.223 | 0.221 |
| K_{Ic} (CN) (MPa · m^{1/2}) | — | — | — | — | — |
| Refractive index | 1.5243 | 1.5136 | 1.5192 | 1.5183 | 1.5242 |
| SOC (nm/mm/MPa) | 3.007 | 3.037 | 2.993 | 2.925 | 2.869 |
| VFT A | −2.619 | −3.333 | −2.707 | −3.434 | −2.534 |
| VFT B | 6514.4 | 8315.3 | 6763.3 | 8544.9 | 6492.7 |
| VFT To | 164.7 | 35.3 | 135.4 | −2.4 | 125 |
| Liquidus (gradient boat) | 24 | 24 | 24 | 24 | 24 |
| duration (hours) | | | | | |
| Air interface liquidus | 1180 | 1240 | >1285 | 1030 | 1090 |
| temperature (° C.) | | | | | |
| Internal liquidus temperature | 1170 | 1230 | >1285 | 1030 | 1080 |
| (° C.) | | | | | |
| Platinum interface liquidus | 1170 | 1230 | >1285 | 1025 | 1065 |
| temperature (° C.) | | | | | |
| Liquidus Viscosity (kP) | 7 | 4 | — | 70 | 18 |

| Example | C1 |
|---|---|
| SiO₂ | 63.70 |
| Al₂O₃ | 16.18 |
| P₂O₅ | 2.64 |
| B₂O₃ | 0.39 |
| MgO | 0.33 |
| CaO | — |
| Li₂O | 8.04 |
| Na₂O | 8.10 |
| K₂O | 0.53 |
| TiO₂ | 0.01 |
| SnO₂ | 0.05 |
| Fe₂O₃ | 0.02 |
| WO₃ | — |
| Y₂O₃ | — |
| R₂O | 16.67 |
| Al₂O₃ + B₂O₃ | 16.57 |
| TiO₂ + WO₃ + Y₂O₃ | 0.01 |

As indicated by the example glass compositions in Table 1, glass compositions and the resultant glass articles as described herein have increased K_{Ic} fracture toughness such that the glass compositions and the resultant glass articles are more resistant to damage.

Table 2 shows the CS, DOL, and CT of comparative ion exchanged glass article CA1 and example ion-exchanged glass articles EA1-EA12 formed by ion exchanging glass articles having a thickness of 0.8 mm and made from a comparative glass composition and example glass compositions, as indicated in Table 2, at a temperature of 380° C. for 2, 4, and 6 hours. The ion exchange solution was a 80 wt % KNO₃/20 wt % NaNO₃ molten salt bath.

TABLE 2

| | Example | | | | |
|---|---|---|---|---|---|
| | EA1 | EA2 | EA3 | EA4 | EA5 |
| Composition | E7 | E8 | E9 | E10 | E11 |

2 hours

| | | | | | |
|---|---|---|---|---|---|
| CS (MPa) | 699 | 715 | 710 | 687 | 686 |
| DOL (μm) | 8.7 | 6.9 | 6.4 | 9.2 | 7.2 |
| CT (MPa) | 85.7 | 83.4 | 93.1 | 86.4 | 78.4 |

4 hours

| | | | | | |
|---|---|---|---|---|---|
| CS (MPa) | 668 | 684 | 666 | 664 | 661 |
| DOL (μm) | 11.8 | 9.6 | 9.3 | 12 | 10.4 |
| CT (MPa) | 92.1 | 92.4 | 107.8 | 91.2 | 86.3 |

6 hours

| CS (MPa) | 655 | 666 | 647 | 643 | 643 |
|---|---|---|---|---|---|
| DOL (μm) | 14.8 | 12.2 | 9 | 15.3 | 13.1 |
| CT (MPa) | 94.9 | 92.6 | 113.5 | 93.5 | 92.1 |
| | Example | | | | |
| | EA6 | EA7 | EA8 | EA9 | EA10 |
| Composition | E12 | E13 | E14 | E15 | E16 |

2 hours

| | | | | | |
|---|---|---|---|---|---|
| CS (MPa) | 672 | 670 | 672 | 666 | 651 |
| DOL (μm) | 7.1 | 9.5 | 8.7 | 9.4 | 9.4 |
| CT (MPa) | 72.4 | 74.2 | 75.1 | 76.1 | 77.4 |

4 hours

| | | | | | |
|---|---|---|---|---|---|
| CS (MPa) | 669 | 651 | 634 | 653 | 626 |
| DOL (μm) | 10.0 | 12.3 | 12.1 | 12.1 | 12.4 |
| CT (MPa) | 78.4 | 85.1 | 85.4 | 87.6 | 80.1 |

6 hours

| | | | | | |
|---|---|---|---|---|---|
| CS (MPa) | 657 | 636 | 633 | 630 | 613 |
| DOL (μm) | 12.5 | 15.2 | 15.3 | 15.3 | 15.3 |
| CT (MPa) | 84.5 | 82.7 | 85.7 | 86.8 | 79.5 |

| | Example | | |
|---|---|---|---|
| | EA11 | EA12 | CA1 |
| Composition | E17 | E18 | C1 |

2 hours

| | | | |
|---|---|---|---|
| CS (MPa) | 630 | 609 | 682 |
| DOL (μm) | 9.8 | 10.2 | 9.7 |
| CT (MPa) | 68.8 | 58.8 | 72.2 |

4 hours

| | | | |
|---|---|---|---|
| CS (MPa) | 618 | 584 | 669 |
| DOL (μm) | 12.5 | 13.4 | 12.7 |
| CT (MPa) | 75.7 | 66.2 | 80.7 |

6 hours

| | | | |
|---|---|---|---|
| CS (MPa) | 605 | 577 | 658 |
| DOL (μm) | 15.4 | 17.9 | 15.7 |
| CT (MPa) | 75.1 | 65.2 | 80.5 |

As indicated by the example ion exchanged glass articles in Table 2, glass articles formed from the glass compositions having increased K_{Ic} fracture toughness as described herein may be ion exchanged to achieve desired stress profiles.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass composition comprising:
greater than or equal to 55 mol % and less than or equal to 70 mol % SiO₂;
greater than or equal to 12.5 mol % and less than or equal to 17.25 mol % Al₂O₃;
greater than or equal to 0.1 mol % and less than or equal to 3.5 mol % P₂O₅;
greater than or equal to 0 mol % and less than or equal to 5.5 mol % B₂O₃;
greater than or equal to 6 mol % and less than or equal to 10 mol % Li₂O;
greater than or equal to 3 mol % and less than or equal to 10 mol % Na₂O;
greater than or equal to 0 mol % and less than or equal to 3 mol % TiO₂;
greater than or equal to 0 mol % and less than or equal to 3 mol % WO₃; and
greater than or equal to 0 mol % and less than or equal to 3 mol % Y₂O₃, wherein
Al₂O₃+B₂O₃ is greater than or equal to 12.5 mol % and less than or equal to 22.5 mol %, and
TiO₂+WO₃+Y₂O₃ is greater than or equal to 0.2 mol % and less than or equal to 3 mol %.

2. The glass composition of claim 1, wherein TiO₂+WO₃+Y₂O₃ is greater than or equal to 0.4 mol % and less than or equal to 3 mol %.

3. The glass composition of claim 1, wherein Al₂O₃+B₂O₃ is greater than or equal to 13.5 mol % and less than or equal to 21.5 mol %.

4. The glass composition of claim 1, wherein the glass composition comprises greater than or equal to 0.1 mol % and less than or equal to 5.25 mol % B₂O₃.

5. The glass composition of claim 1, wherein the glass composition comprises greater than or equal to 13 mol % and less than or equal to 17 mol % Al₂O₃.

6. The glass composition of claim 1, wherein R₂O is greater than or equal to 9 mol % and less than or equal to 20 mol %, R₂O being the sum of Li₂O, Na₂O, and K₂O.

7. The glass composition of claim 1, wherein the glass composition comprises greater than 0 mol % and less than or equal to 1 mol % K₂O.

8. The glass composition of claim 1, wherein the glass composition comprises greater than 0 mol % and less than or equal to 3 mol % TiO₂.

9. The glass composition of claim 1, wherein the glass composition comprises greater than 0 mol % and less than or equal to 3 mol % WO₃.

10. The glass composition of claim 1, wherein the glass composition comprises greater than 0 mol % and less than or equal to 3 mol % Y₂O₃.

11. The glass composition of claim 1, wherein the glass composition has a K_{Ic} fracture toughness as measured by a chevron notch short bar method greater than or equal to 0.7 MPa·m^{1/2}.

12. A glass article comprises:
greater than or equal to 55 mol % and less than or equal to 70 mol % SiO₂;
greater than or equal to 12.5 mol % and less than or equal to 17.25 mol % Al₂O₃;
greater than or equal to 0.1 mol % and less than or equal to 3.5 mol % P₂O₅;
greater than or equal to 0 mol % and less than or equal to 5.5 mol % B₂O₃;
greater than or equal to 6 mol % and less than or equal to 10 mol % Li₂O;
greater than or equal to 3 mol % and less than or equal to 10 mol % Na₂O;
greater than or equal to 0 mol % and less than or equal to 3 mol % TiO₂;
greater than or equal to 0 mol % and less than or equal to 3 mol % WO₃; and
greater than or equal to 0 mol % and less than or equal to 3 mol % Y₂O₃, wherein
Al₂O₃+B₂O₃ is greater than or equal to 12.5 mol % and less than or equal to 22.5 mol %, and
TiO₂+WO₃+Y₂O₃ is greater than or equal to 0.2 mol % and less than or equal to 3 mol %.

13. The glass article of claim 12, wherein TiO₂+WO₃+Y₂O₃ is greater than or equal to 0.4 mol % and less than or equal to 3 mol %.

14. The glass article of claim 12, wherein Al₂O₃+B₂O₃ is greater than or equal to 13.5 mol % and less than or equal to 21.5 mol %.

15. The glass article of claim 12, wherein the glass article comprises greater than or equal to 0.1 mol % and less than or equal to 5.25 mol % B₂O₃.

16. The glass article of claim 12, wherein the glass article comprises greater than or equal to 13 mol % and less than or equal to 17 mol % Al₂O₃.

17. The glass article of claim 12, wherein R₂O is greater than or equal to 9 mol % and less than or equal to 20 mol %, R₂O being the sum of Li₂O, Na₂O, and K₂O.

18. The glass article of claim 12, wherein the glass article is an ion exchanged glass article.

19. The glass article of claim 18, wherein the ion exchanged glass article comprises a peak surface compressive stress greater than or equal to 450 MPa, a depth of layer greater than or equal to 5 μm, and a maximum central tension greater than or equal to 50 MPa, as measured at an article thickness of 0.8 mm.

20. A method of forming a glass article, the method comprising:
heating a glass composition, the glass composition comprising:
greater than or equal to 55 mol % and less than or equal to 70 mol % SiO₂;
greater than or equal to 12.5 mol % and less than or equal to 17.25 mol % Al₂O₃;
greater than or equal to 0.1 mol % and less than or equal to 3.5 mol % P₂O₅;
greater than or equal to 0 mol % and less than or equal to 5.5 mol % B₂O₃;
greater than or equal to 6 mol % and less than or equal to 10 mol % Li₂O;
greater than or equal to 3 mol % and less than or equal to 10 mol % Na₂O;
greater than or equal to 0 mol % and less than or equal to 3 mol % TiO₂;
greater than or equal to 0 mol % and less than or equal to 3 mol % WO₃; and
greater than or equal to 0 mol % and less than or equal to 3 mol % Y₂O₃, wherein
Al₂O₃+B₂O₃ is greater than or equal to 12.5 mol % and less than or equal to 22.5 mol %, and
TiO₂+WO₃+Y₂O₃ is greater than or equal to 0.2 mol % and less than or equal to 3 mol %; and
cooling the glass composition to form the glass article.
